(19) United States
(12) Patent Application Publication
(10) Pub. No.: US 2012/0151397 A1
(43) Pub. Date: Jun. 14, 2012

(54) Access to an electronic object collection via a plurality of views

(75) Inventors: Tobias Gregor Oberstein, Herzogenaurach (DE); Alexander Goedde, Roth (DE)

(73) Assignee: TAVENDO GMBH, Herzogenaurach (DE)

(21) Appl. No.: 12/962,681

(22) Filed: Dec. 8, 2010

(51) Int. Cl. G06F 3/048; G06F 17/30

(52) U.S. Cl. 715/769; 707/722; 715/784; 707/E17.005

(57) ABSTRACT

Computing devices, methods and other implementations for access to an electronic object collection via a plurality of views are described herein. Views contain items that reference objects in an electronic object collection. A plurality of views is provided, and at least one of said plurality of views is displayed. The views may be populated through a search function on the object collection. The objects in the object collection may be accessed via the items referencing the objects. Items may be deleted from a view, and items may be copied or moved from a view to another view without deleting an object referenced by a deleted item from the object collection or copying an object referenced by a copied item within the object collection.

### FIELD OF THE INVENTION

The embodiments described herein relate to graphical computer interfaces. More specifically, they relate to graphical computer interfaces that enable and improve access to an object collection.

### BACKGROUND

With today's computer systems, with their ability to handle a wide variety of different tasks, their large local storage capacity and fast connectivity, users are faced with large numbers of objects, such as documents and audio and video files, to search, sort through and access during their business and private use of these computer systems.

Traditionally file browsers have been a central tool for enabling these actions on a system level. Various applications, such as search tools, tool palettes, shortcut bars and application launchers are used additionally. Software applications that offer access to a plurality of objects offer different interfaces, some of them based on user interface conventions of the operating system or systems they run on, some proprietary.

### SUMMARY

Computing devices, methods and other implementations for access to an electronic object collection via a plurality of views are described herein. Views contain items that reference objects in an electronic object collection. A plurality of views is provided, and at least one of said plurality of views is displayed. The views may be populated through a search function on the object collection. The objects in the object collection may be accessed via the items referencing the objects. Items may be deleted from a view, and items may be copied or moved from a view to another view without deleting an object referenced by a deleted item from the object collection or copying an object referenced by a copied item within the object collection.

### BRIEF DESCRIPTION OF THE DRAWINGS

FIG. 1 illustrates an example computing device suitable for implementing at least one embodiment of the invention.

FIG. 2 illustrates an example system architecture suitable for implementing at least one embodiment of the invention.

FIG. 3 illustrates an example system architecture suitable for implementing at least one embodiment of the invention.

FIG. 4 illustrates an object collection with items referencing some objects.

FIG. 5 illustrates two views containing items.

FIG. 6 illustrates two views and an object collection.

FIG. 7 illustrates moving an item from one view to another.

FIG. 8 illustrates copying an item from one view to another.

FIG. 9 illustrates moving an item within a view.

FIG. 10 illustrates a logic for determining whether an item is to be moved or copied.

FIG. 11 illustrates a logic for determining whether a view containing an item is to be scrolled.

FIG. 12 illustrates the display of an object referenced by an item in a view.

FIG. 13 illustrates populating a view with items through a tag search.

FIG. 14 illustrates the relationship between content, objects and items.

FIG. 15 illustrates the relationship between content and objects.

FIG. 16 illustrates icons as graphical representations for items in a view.

FIG. 17 illustrates the relationship between an object and icons that graphically represent items referencing the object.

FIG. 18 illustrates different graphical displays of a view.

FIG. 19 illustrates an arrangement of views.

FIG. 20 illustrates an arrangement of views.

FIG. 21 illustrates moving a view relative to other views in an arrangement of views.

FIG. 22 illustrates an arrangement of views.

FIG. 23 illustrates an arrangement of views with a ‘docking’ effect.

FIG. 24 illustrates a computing device with a viewport on a screen.

FIG. 25 illustrates a view displayed in a viewport.

FIG. 26 illustrates an arrangement of views displayed in a viewport.

FIG. 27 illustrates a viewport displaying an arrangement of views in a windows environment.

FIG. 28 illustrates vertical scrolling of an arrangement of views in a viewport.

FIG. 29 illustrates horizontal scrolling of an arrangement of views in a viewport.

FIG. 30 illustrates panning of an arrangement of views in a viewport.

FIG. 31 illustrates the scrolling of a viewport on a stack of views.

FIG. 32 illustrates panning a view within a display area for the view in an arrangement of views.

FIG. 33 illustrates moving a view to a different position in an arrangement of views.

FIG. 34 illustrates a logic for displacing views in an arrangement of views when a view is moved to a different position.

FIG. 35 illustrates ‘dropping’ a view onto another view in an arrangement of views.

FIG. 36 illustrates several results for a actions performed on two views.

FIG. 37 illustrates a logic for determining that a view is moved to a different position in an arrangement of views.

FIG. 38 illustrates a logic for determining that a view is ‘dropped’ on another view in an arrangement of views.

FIG. 39 illustrates the deletion of a view and the subsequent addition of a view to an arrangement of views.

FIG. 40 illustrates cloning a view in an arrangement of views.

FIG. 41 is a flow chart for an embodiment where the plurality of views is arranged as a stack of views.

FIG. 42 is a flow of the determination of an item or view action.

FIG. 43 is a flow of accessing an item.

FIG. 44 is a flow of scrolling and switching.

FIG. 45 illustrates an item with an overlaid delete button.

FIG. 46 is a flow for the copying, moving or deleting of an item.

FIG. 47 is a flow for the operation of a view context menu.

FIG. 48 is a flow for the addition of a new view to a stack of views.

FIG. 49 is a flow for the deletion of a view from a stack of views.

FIG. 50 is a flow for a population of a view through a search on an object collection.

### DETAILED DESCRIPTION

Described herein are a computing device and a method suitable for the implementation of access to an electronic object collection via an arrangement of views. In the course of this description, reference is made to the accompanying drawings that form a part hereof. Like reference numerals are used to refer to like elements throughout.

While specific configurations, features and arrangements are shown in the drawings and discussed, this is done for illustrative purposes only. A person skilled in the art will recognize that they may practice other embodiments of the invention without one or more of the steps, features or components described below, and that other configurations, features and arrangements may be used without departing from the spirit and scope of the invention.

For the sake of brevity, certain well-known details often associated with computing and software technology are not set forth in the following disclosure. In some cases, well-known structures and devices are shown in block diagram form in order to facilitate describing these elements.

In addition, the embodiments described herein may be implemented as a method or apparatus using commonly known programming and/or engineering techniques to produce software, firmware, hardware or any combination thereof to control a computer to implement the disclosed embodiments.

When reference is made to a mobile computing device it should be understood that other computing devices having the necessary components may be used to implement the invention.

### Computing Device

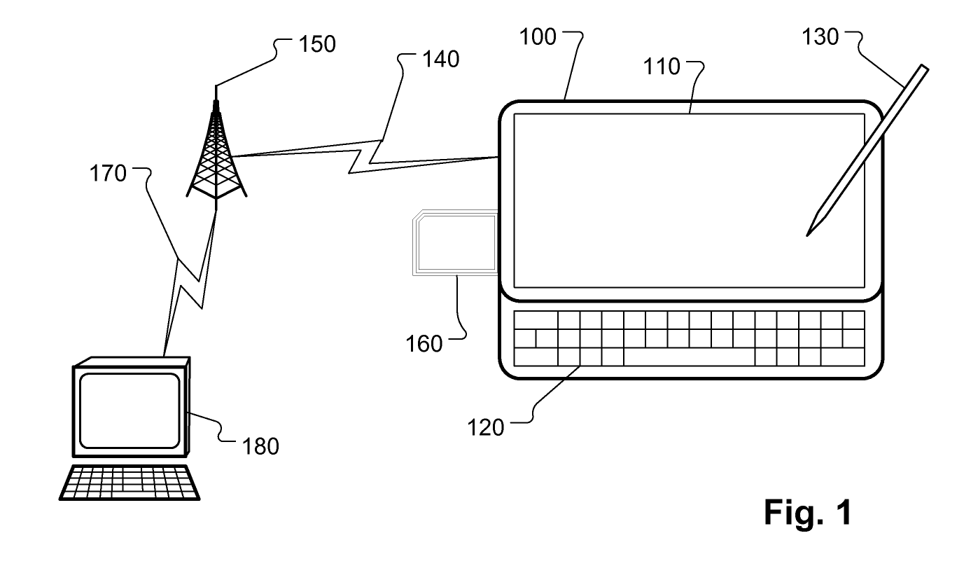

A computing device suitable for an implementation of access to an electronic object collection via an arrangement of views is illustrated in FIG. 1. It is illustrated as a mobile computing device 100 which is connected to a wireless data network 150 through a wireless connection 140. Other network connections such as, but not limited to, wired Ethernet networks are also possible, and it should be appreciated that the principles of the invention may be utilized as well by devices that are not connected to a computer network.

The mobile computing device 100 includes a display 110. In the present illustration, the display 110 doubles as a pointing device by including a touch screen for operation with a stylus 130. Other pointing devices such as, but not limited to, dedicated hardware keys, D-pads, mice, digitizer tablets, resistive or capacitive touch screens intended for finger or stylus operation or analogue joysticks may be used as well. Mass storage may be fixed internally, be provided through a removable storage means such as one or more flash memory storage cards 160, or be connected to the computing device externally, such as through a data network. The device may also include a keyboard 120. In addition to or instead of the touch screen 110 and the keyboard 120 other input devices such as dedicated hardware keys, D-pads, mice, digitizer tablets, resistive or capacitive touch screens intended for finger or stylus operation or analogue joysticks may be used. The mobile computing device 100 operates under the control of an operating system, and executes various computer software applications as well as system processes. In a device connected to a data network, computer software applications or some of their processes, including components of the present invention, may also be executed on a server or other computer 180 connected to the network by, for example, but not limited to, a wireless connection 170. The computer display 110 may be any type of display such as, most usually, but not limited to, an LCD, or an OLED.

Examples of a computing device suitable for implementation of access to an electronic object collection via an arrangement of views are mobile internet devices such as the Nokia N800, N810, smartphones such as the Nokia N97 or HTC Desire, tablet computers such as the Lenovo ThinkPad X60t, X201t, Hewlett-Packard EliteBook 2740p, Archos 70 internet tablet, notebook computers such as the Lenovo ThinkPad T400, Hewlett-Packard ProBook 5310m and desktop systems such as the Dell Studio One 19, Apple iMac.

### Suitable Architecture

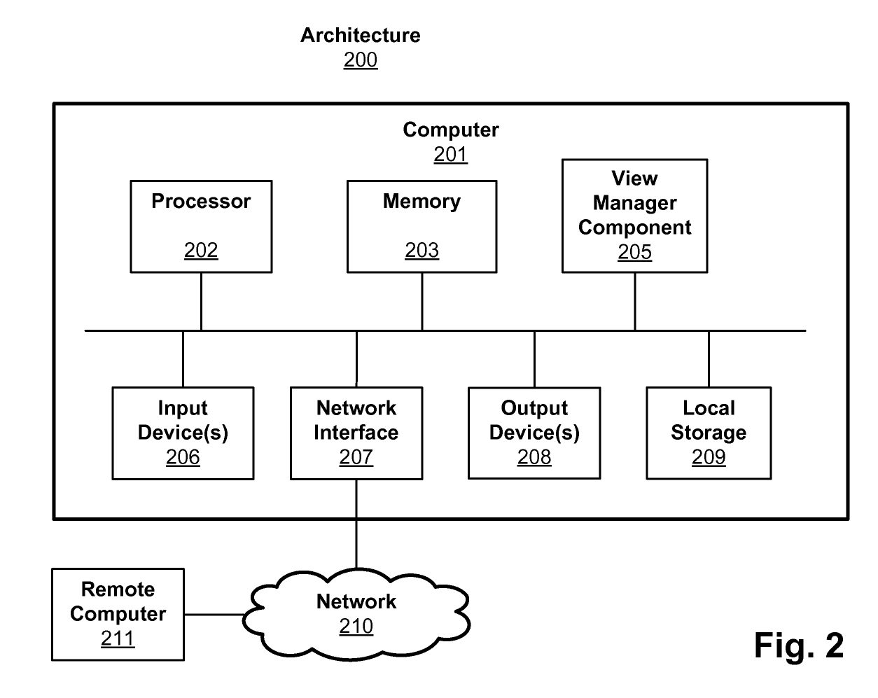

FIG. 2 is a block diagram of a suitable architecture 200 (e.g. hardware architecture) for implementing access to an electronic object collection via an arrangement of views. The architecture includes a computing device 201 that is frequently connected to one or more remote computing devices 211 via a network interface 207 and network 210. This network can be any other type of network including a Wi-Fi network, Ethernet network, GSM network, or 3G network. The computing device 201 includes at least one processor 202, a memory 203, at least one input device 206, which may preferably be a pointing device and possibly additional input devices such as, but not limited to, keyboards, cameras, microphones, game pads, and one or more output devices 208, e.g. displays and devices for audio or tactile feedback. The user interacts with the computing device through the input and output devices 206, 208. User input relevant to the present invention is processed by a view manager component 205 to translate relevant user input into presentation of and changes in views. The computing device 201 also includes a local storage device 209, which can be a computer-readable medium. The term “computer-readable medium” refers to any medium that can be part of the process of providing instructions to a processor for execution. This can, amongst others, include non-volatile media (e.g. magnetic or optical disks), volatile media (e.g. random access memory) and transmission media such as electrical busses, radio frequency waves or others. The computer readable medium does not need to be locally connected to the computing device, but may also reside on a remote computing device connected via a network.

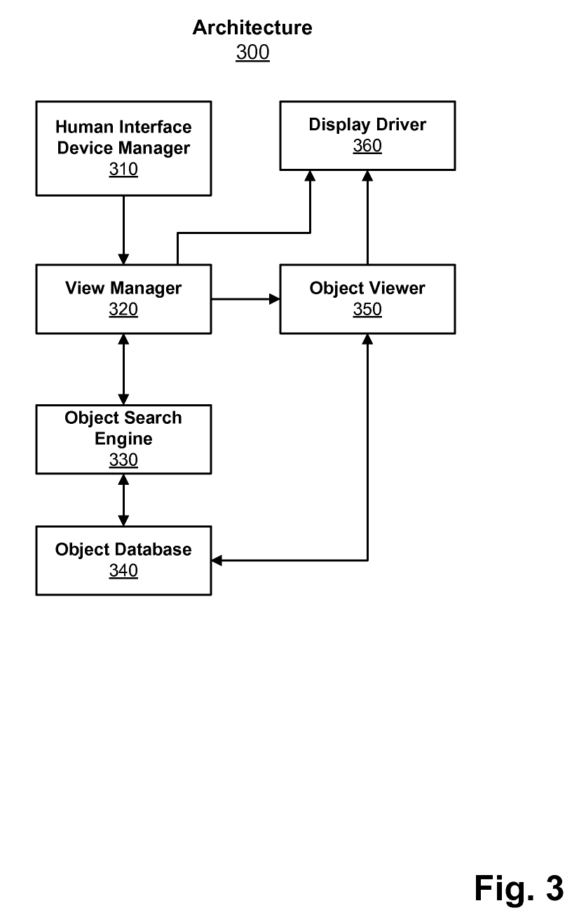

FIG. 3 is a block diagram of a suitable architecture 300 (e.g. software architecture) for implementing access to an electronic object collection via an arrangement of views. A human interface device manager 310 receives and processes input from human interface devices such as, but not limited to, a pointing device, and is connected to a view manager 320 to which it passes this processed input. The view manager 320 is connected to an object search engine 330. It initiates searches by the object search engine 330. The object search engine 330 is connected to an object database 340 on which it runs these searches. Results from the object database 340 are returned to the object search engine 330, which returns them to the view manager 320. The view manager is further connected to an object viewer 350, to which it passes received requests for viewing an object. The object viewer 350 is connected to the object database 340, from which it requests objects to display. The object database 340 transfers the data of the requested objects to the object viewer 350. Both the view manager 320 and the object viewer 350 are connected to a display driver 360, to which views and objects respectively that are to be displayed are transferred.

### Object Collection, Items and Views

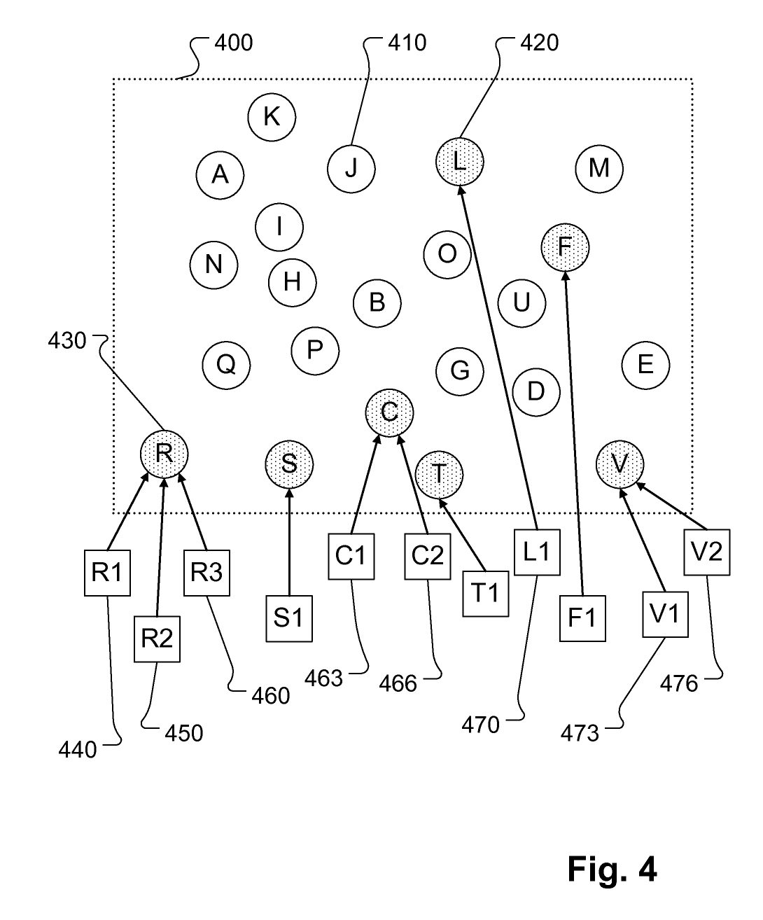

FIG. 4 is a graphical representation of an object collection 400, which contains objects such as 410, 420, 430. It also shows items such as 440, 450, 460, 463, 466, 470, 473, 476 that reference these objects. There may be multiple items which reference an object, such as 440, 450 and 460, which each reference object 430, a single item that references a single object, such as 470 for 420, and objects may not be referenced by any item, such as object 410. Note that here and in subsequent drawings, items are identified by a letter indicating the object the reference, and a number, where the number serves to distinguish several items referencing the same object from each other. Objects that are referenced by items have been shaded in the graphical representation of object collection 400 for illustrative purposes.

Objects may include, but are not limited to, text files, word processing documents, HTML documents, XML documents, spreadsheets, presentations, images, video files, audio files and program source code. Objects may also be references to other objects, or consist of or comprise parts of other objects.

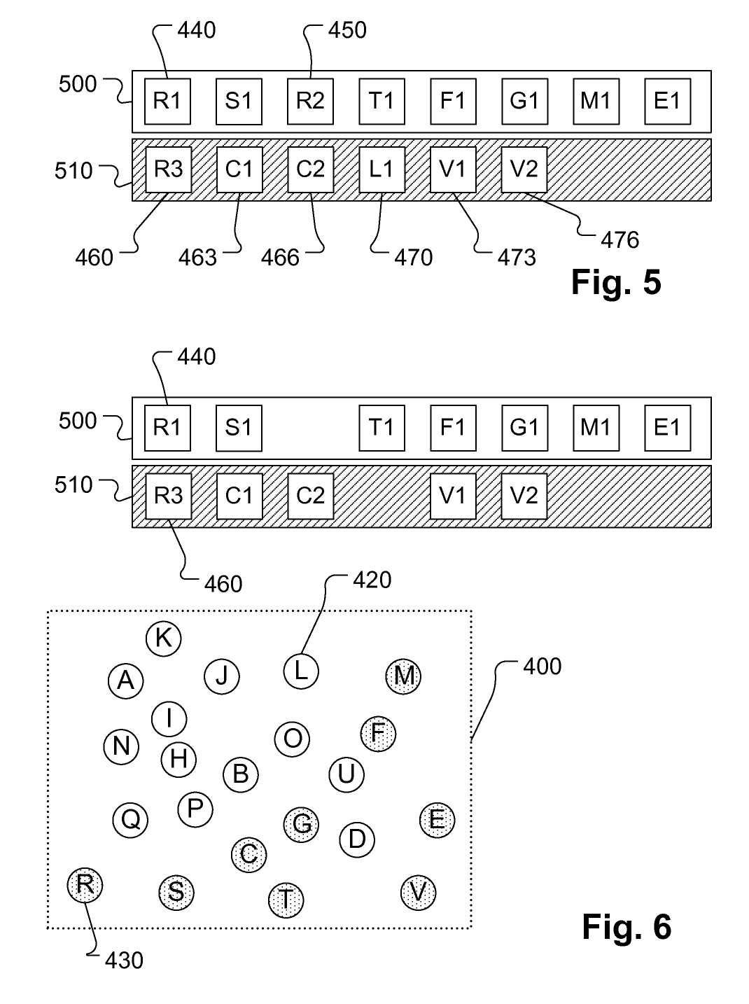

Creating, deleting or otherwise changing an item does not influence the object referenced by that item. While several items may contain the same reference, they may differ in other respects such as, but not limited to, the view that they are contained in, the position they are displayed at within a view, an item access history or an item display state. A reference may be any kind of information that uniquely identifies an object in an object collection, such as, but not limited to, a file name and file path for an object that is a file in a file system, a pointer for an object that is an entry in a database, and a URL for an object that is web-accessible. FIG. 5 illustrates two views that contain multiple items. Both view 500 and 510 contain items (440, 450, 460) that reference an object R. View 500 contains two such items (440, 450), while view 510 contains just a single one (460). Additionally, view 510 contains two items (463, 466) that reference an object C and two items (473, 476) that reference an object V.

In FIG. 6, item 450, which was contained in view 500 in FIG. 5, and was one of the two items in the first view 500 that reference an object 430 in an object collection 400, has been deleted. The other items, which also reference object 430, 440 in the first view 500 and 460 in the second view 510, have not been influenced by this deletion. Additionally, the single item 470 that references object 420 has been deleted from the second view 510. Neither deletion has deleted the objects 430 or 420 referenced by the deleted items, and has also not changed any other items in the views or objects in the object collection. Objects that are referenced by items have been shaded in the graphical representation of object collection 400 for illustrative purposes.

It will be appreciated, however, that within an embodiment, an item may be used as the starting point for operations that influence the object said item references, e.g. a context menu called up with a right-click on an item in an embodiment running in e.g. a Microsoft™ Windows™ environment may contain a ‘delete referenced object’ command. If such a command is executed, then not only the object but also the item is deleted as a consequence of the item now containing no valid reference anymore, so that its existence and display does not fulfill any purpose to the user.

It will further be appreciated that while here only items are shown as being displayed in a view, other elements may be displayed as part of a view, as a graphical overlay over a view, as elements bordering a view or otherwise in relationship to a view. Such elements may include, but are not limited to, graphical user interface control elements, displays of information associated with items, displays of information associated with the view, displays of information associated with a currently executed action, displays of information associated with a previously executed action, and displays of information associated with presently possible actions, such as, but not limited to, copying an item, moving an item, deleting an item, reordering the display of items in the view, and accessing an object referenced by an item.

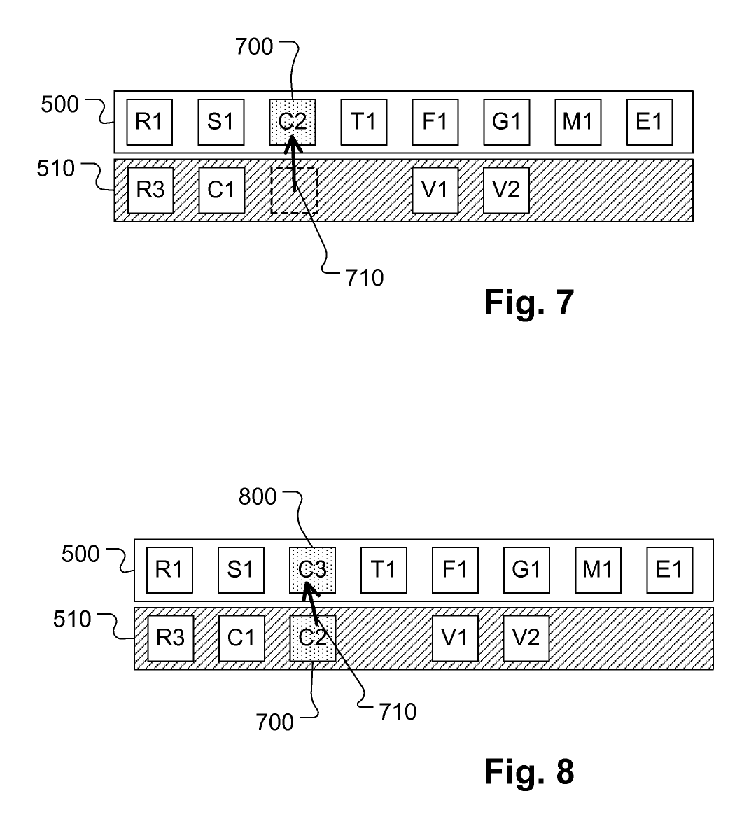

FIG. 7 illustrates moving an item from one view to another. Initially item 700 was contained in view 510, but is now contained in view 500. This is the only aspect of item 700 that changes through this moving.

Such moving may be effected by a user input 710 such as, but not limited to, a drag and drop action using a pointing device in a conventional GUI system. Such moving may further be caused program-controlled, such as, but not limited to, automatically removing an item from a view that compiles newly added and yet unaccessed items in the object collection once such an item has been accessed by the user.

FIG. 8 shows copying an item. Item 700 in view 510 has been copied to view 500. The resulting copy 800 in view 500 references the same object, but the items now each have a separate existence, e.g. deleting item 800 does not influence item 700 and vice versa. The object referenced by both item 700 and 800 is not influenced by the copy operation.

### User Input on Items

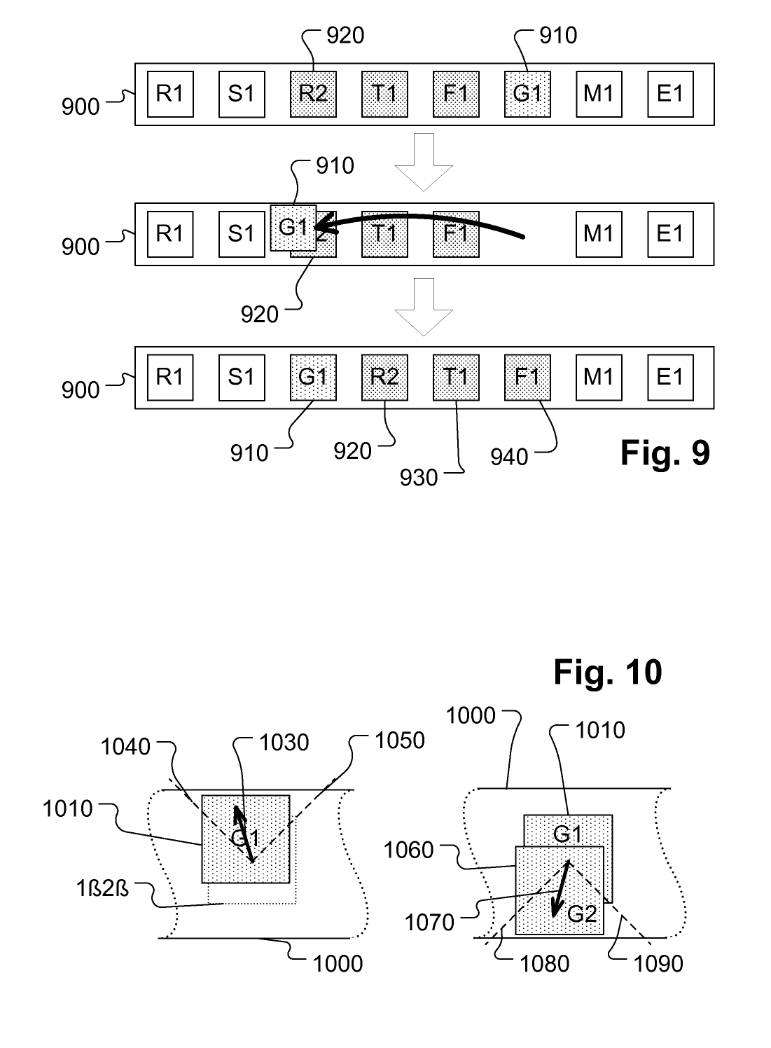

FIG. 9 illustrates rearranging items within a view. In the middle perspective of FIG. 9, item 910 has been moved from its initial position shown in the top perspective of FIG. 9. In the bottom perspective of FIG. 9, item 910 is at a new position within view 900, which is to the left of its original position. Items 920, 930, 940, which are between the new position of 910 and its initial position, have been displaced to the right, so that there is no gap at the former position of 910.

While here rearranging the items in a view is shown through direct user manipulation of an item, it will be appreciated that there may be other ways of rearranging items in a view. Items in a view may be ordered program-controlled according to criteria such as, but not limited to, the date of the creation of an object, the date of the addition of an object to the object collection, the date or time an item was added to a view, the content type of an object referenced by an item, the file handlers assigned to the content type of an object referenced by an item, the date and time an object referenced by an item was last accessed, the date and time an object referenced by an item was last edited, whether an object has yet been accessed through an item referencing it in the view, shared tags between objects and a weighted importance score based on a mix of factors assigned by an application displaying the view.

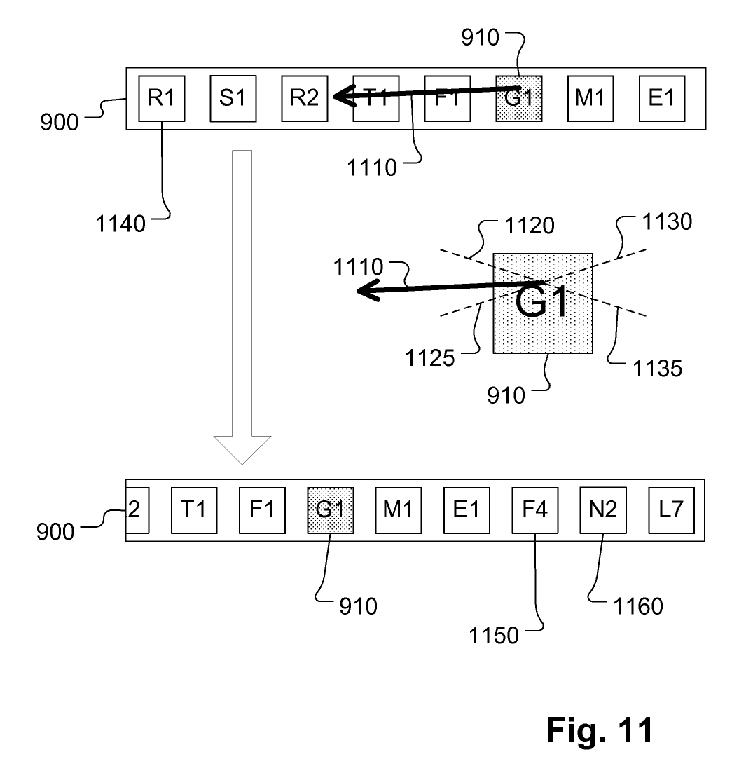

FIG. 10 and FIG. 11 illustrate a possibility to determine, via initial drag direction, what action is to be carried out when a drag starts within the graphical representation of an item.

FIG. 10 illustrates a determination whether an item is copied or moved.

In the left perspective, a drag upwards and to the left has started on the graphical representation of item 1010, which is contained in a view 1000. The direction of the dragging vector 1030 is at an angle that falls within a range shown by border lines 1040 and 1050. Dragging within this range initiates moving of the item. To indicate the initial place of item 1010, and where the item will be displayed should the move be canceled, an outline 1020 of item 1010 is here displayed at its initial position.

In the right perspective, a drag downwards and to the left has start on the graphical representation of item 1010. The direction of the dragging vector 1070 is at an angle that falls within a range shown by border lines 1080 and 1090. Dragging within this range initiates copying of the item. Item 1010 remains at its initial position, and item 1060, which references the same object 1010, has been created, and is dragged by the user input.

The determination of whether an item is copied or moved may similarly apply to moving or copying an item within a view as to moving or copying an item between views.

FIG. 11 illustrates the determination of whether a view is to be scrolled based on the initial drag direction.

In the top perspective of FIG. 11, a drag is executed that starts within the graphical representation of item 910. As illustrated in the middle perspective of FIG. 11, the direction of the dragging vector 1110 falls within a range between border lines 1120, 1125. Dragging within this range initiates scrolling of the view the item is contained in to the left. A direction of the dragging vector that falls within a range between border lines 1130, 1135 initiates scrolling of the view to the right. In the bottom perspective of FIG. 11 view 900 has been scrolled leftwards, and items such as 1140 are no longer displayed while items such as 1150, 1160 are displayed.

It will be appreciated while here scrolling of a view initiated by dragging initiated within the graphical representation of an item in a view is shown, scrolling may equally be initiated by pointer input received on the background of a view.

While here moving, copying and scrolling are shown as actions to be carried out when a drag starts within the graphical representation of an item, other actions are possible. For actions to be carried out that concern the item itself, in addition to or instead of copying and moving these may be but are not limited to, deleting an item, copying an item to a clipboard, tagging an item, changing the graphical display of the item and causing the object an item references to be displayed. For actions that do not concern the item itself, in addition to or instead of scrolling a view these may be, but are not limited to, zooming into a view, zooming out of a view, and changing the graphical display of all items in the view.

While here four ranges for determining via initial drag direction what action is to be carried out when a drag starts within the graphical representation of an item are illustrated, it will be appreciated that more ranges may be used to implement the determination of more than four actions. It will also be appreciated that the illustrated angles for the ranges are only examples, and embodiments may implement different angles.

### Accessing Objects

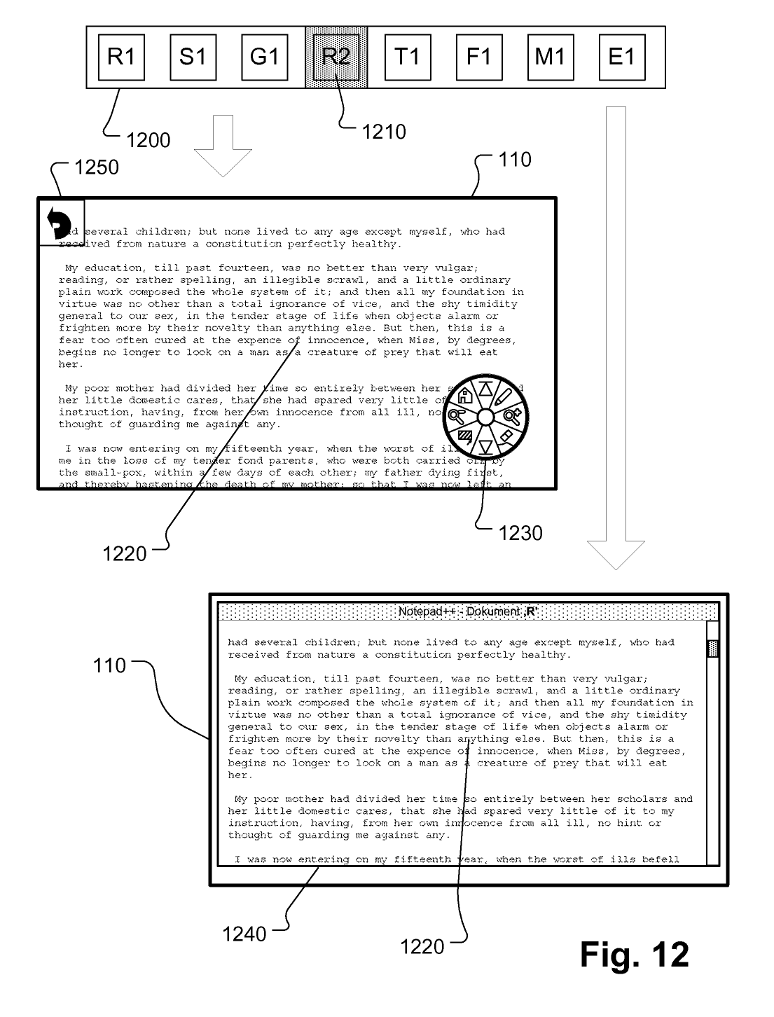

FIG. 12 shows the display of the content of a text object 1220, initiated from an item 1210 referencing said object. The top perspective of FIG. 12 shows a view 1200 containing items such as 1210. Item 1210 references object 1220, which is a text object. User interaction on item 1210 causes object 1220 to be displayed.

In the middle perspective of FIG. 12, this display is integrated into the application implementing access to an electronic object collection via a plurality of views, said application displaying view 1200. In the embodiment shown the display takes up an entire display 110 of a computing device. On screen control elements 1230 and 1250 are displayed as overlays. Element 1230 is a pie menu, which offers options such as zoom controls, a pen and an eraser. Element 1250 is an on-screen button, which changes the display back to the previous display which included view 1200.

In the bottom perspective of FIG. 12, the display of text object 1220 is in an application external to the application displaying view 1200. This application is displayed in a program window 1240 on a display 110 of a computing device.

It will be appreciated that while here a text object is shown, other object content such as, but not limited to, images, audio files, video files, spreadsheets and presentations may be displayed. The display may be adjusted to accommodate specific features of the displayed content, e.g. for audio or video content playback controls may allow for playback of the content.

It will further be appreciated that while here displaying an object when it is accessed from a view is illustrated, embodiments may implement other types of access. Such types of access may include, but are not limited to, launching a system file application handler, launching an application associated with an object type in the settings of the application displaying a view, launching an application that is chosen from a menu displayed to the user upon an initial access input concerning an item, displaying an object as text irrespective of the nature of the object, and executing an executable object.

### Population Through Search

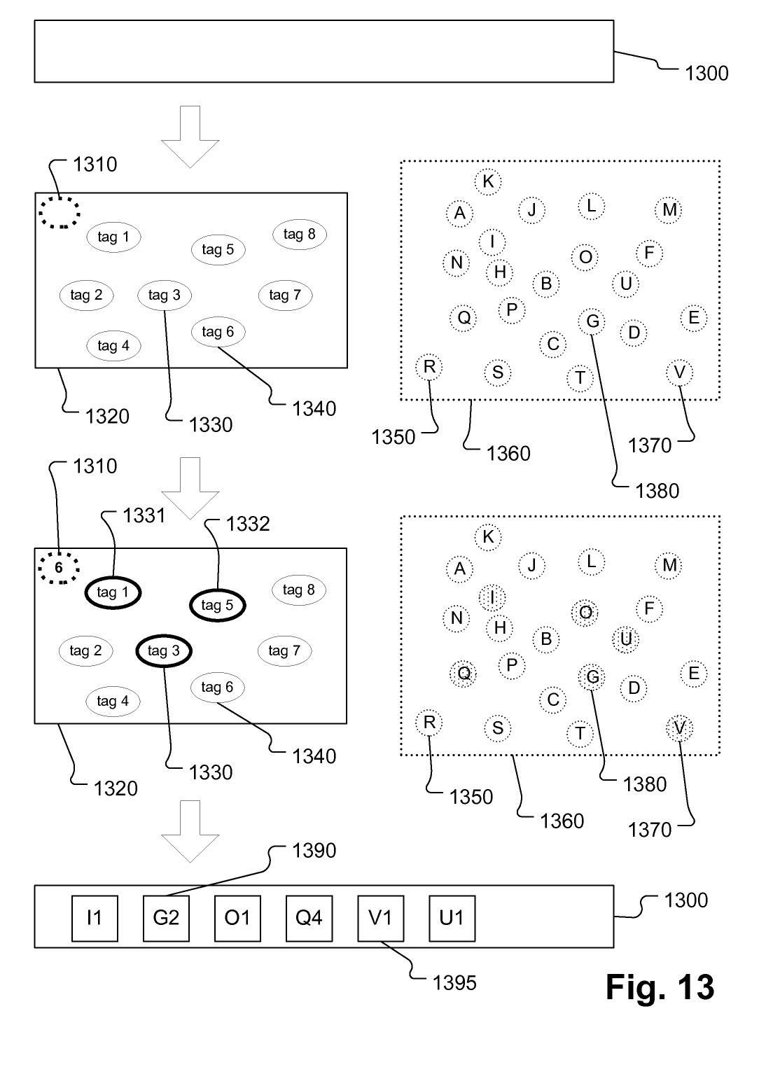

FIG. 13 illustrates the population of an empty view 1300 through a search on an object collection. The top perspective of FIG. 13 shows an empty view 1300. Such an empty view may be created through means such as, but not limited to, a ‘create empty view below current view’ command from a context menu for a view or from a global program menu.

The second perspective of FIG. 13 shows a search screen 1320 using a tag cloud search. This search screen has been called up from view 1300. It will be appreciated that embodiments may employ various ways of initiating a search from a view. Such ways may be, but are not limited to, a context menu for the view which offers a ‘search’ option for user selection, an on-screen control element displayed within the view and a pointer gesture. The tags such as 1330, 1340 are attributes of the objects such as 1350, 1370, 1380 in object collection 1360. They may be data such as, but not limited to, date of creation, date of addition to the object collection and labels such as, but not limited to, terms indicating the importance of an object, a topic it refers to, actions by the user to execute referring to the object, persons relevant in connection with the object and key words relevant in connection with the object. Tags may be generated automatically based on object content, user interaction with the object collection or the object history, or may be input by the user directly, gathered from other user's data in a user community, or come from other data sources external to the object collection. For example, an object may be assigned an ‘image’ tag if the program has determined that it is an image based on the specific file type of the object, a ‘last accessed’ tag may be updated with the access time and date once an object is accessed, a user may assign a tag to an object denoting that the object is relevant in the context of a current project, or a tag to view' may be assigned to an object either by the program when said object is first added to an object collection or by a user.

In the third perspective of FIG. 13, tags 1330, 1331 and 1332 have been selected as part of the tag cloud search. They are added to the query for the tag cloud search, and are linked with a logical ‘AND’. In the graphical representation of object collection 1360, the objects which have the combination of these three tags as attributes, and thus fulfill the conditions for the tag cloud search query, are shaded for illustrative purposes.

In the bottom perspective of FIG. 13, view 1300 is populated with items such as 1390, 1395 that reference those objects from object collection 1360 that are the result of the tag search as illustrated in 1320.

While here a search using a tag cloud is illustrated, it will be appreciated that other kinds of search may be implemented. These include, but are not limited to, text searches within object titles, text searches within object content, Boolean text searches within object titles and/or object content and searches within object metadata. The search function may be implemented in an application or other piece of software that implements access to an electronic object collection via a plurality of views, or be called up as an external search function such as, but not limited to, a search function provided by the operating system of a computing device, or by an external application.

It will be appreciated that while here a search is illustrated that populates an initially empty view with its results, searching is not limited to this specific case. A search may be called up from a view that already contains items, through means such as those for calling up a search from an empty view. In this case the results of the search may either be added to the present content of the view, or replace the present contents. The user may be offered a choice which of the two actions he desires.

A search may further be ‘live’. A live search means that the results of the search are updated. Such an update may be implemented via a periodic repeat of the search on the object collection, an update may be triggered by a change to the object collection, or through any other suitable mechanism. A user may switch off the live search through means such as, but not limited to, an on-screen control element displayed within the view, an option offered in a context menu for a view, and a pointer gesture.

The fact that a search is live may be communicated to the user through the use of a graphical indicator. Such indicators may be, but are not limited to, different colored backgrounds for views which display results of a live search and for those that do not, and an animated indicator such as a pulsating dot in a corner of the displayed part of a view.

Dynamic searches that change the content of a view in combination with user changes to the content of the same view may lead to confusion. For example a user may delete several items from a view. In this case an update to a search may add items referencing the objects referenced by those items deleted by the user, and this may run counter to the user's intention of not having items referencing these objects. On the other hand, if an update of the search were to permanently exclude these objects, then over time, with the user no longer aware of all edits made to the contents of the view, there would be no way for the user to be certain that all potentially relevant results were represented as items in the view. If features such as multiple successive searches to populate a view are implemented, further confusion may arise as to why certain items have been currently added to the view. To avoid such confusion, embodiments may implement turning off live search upon a user changing the contents of a view the results of the live search are displayed in, e.g. when the user deletes or adds of items, or based on some other user action or condition.

### Documents, Objects and Items

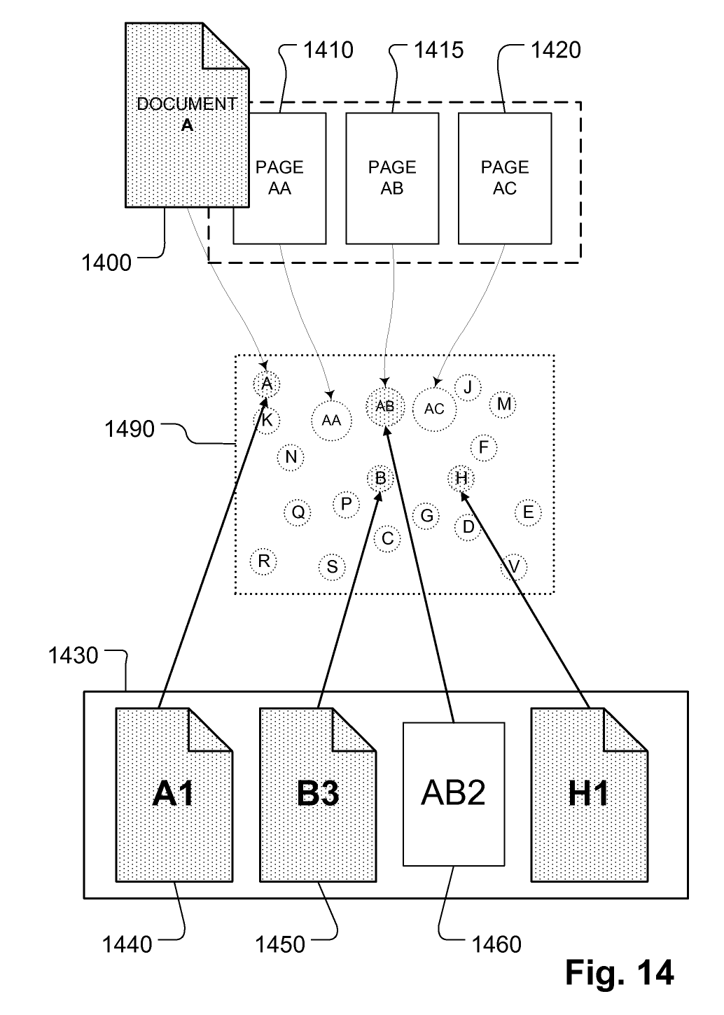

FIG. 14 illustrates the relationship between documents, objects and items. The top of FIG. 14 shows a document 1400. This document consists of three pages, 1410, 1420, 1430. Both the document and the pages are stored as objects within object collection 1490, which is shown in the middle of FIG. 14. The bottom of FIG. 14 shows a view 1430 which contains items 1450, 1460, 1470, 1480. These items reference objects in object collection 1490. As indicated by the difference in icons used as graphical representations for the items, items 1450, 1460 and 1480 reference objects that are documents, while item 1470 references an object that is a page.

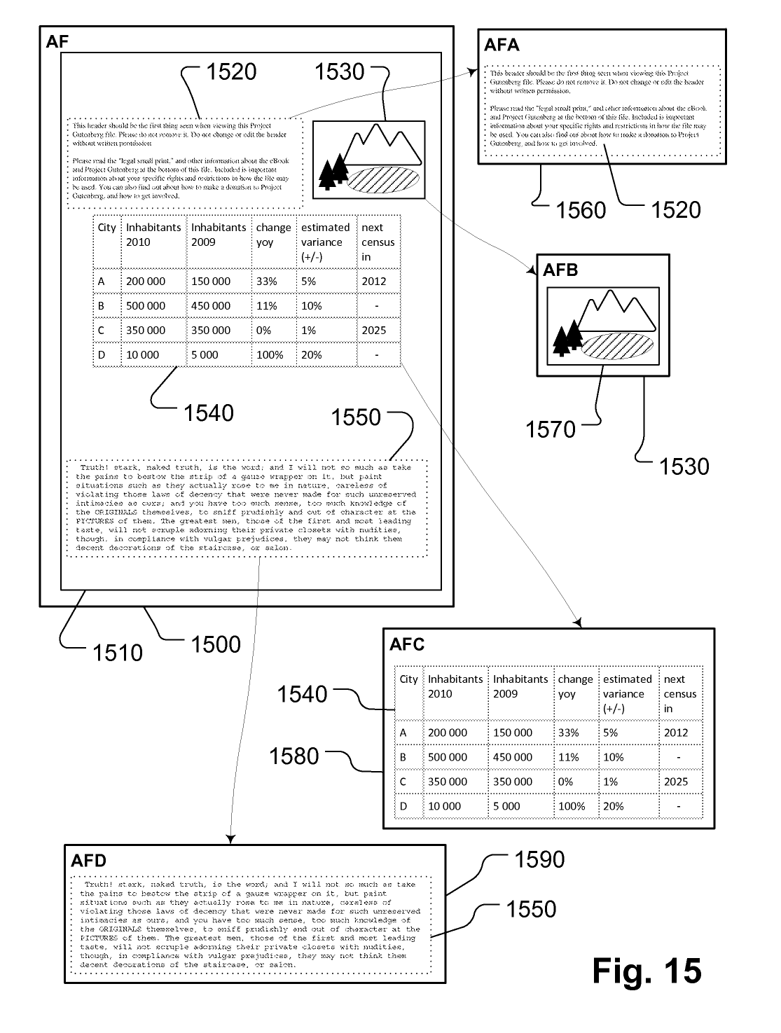

FIG. 15 further illustrates the relationship between pages and their constituent parts. Page 1510 is stored in an object collection as object 1500. Page 1510 contains element such as paragraphs 1520, 1550, image 1530 and table 1540. These elements are stored in the object collection as individual objects: paragraphs 1520, 1550 as objects 1560, 1590, image 1530 as object 1570, table 1540 as object 1580.

### Graphical Representation of Items

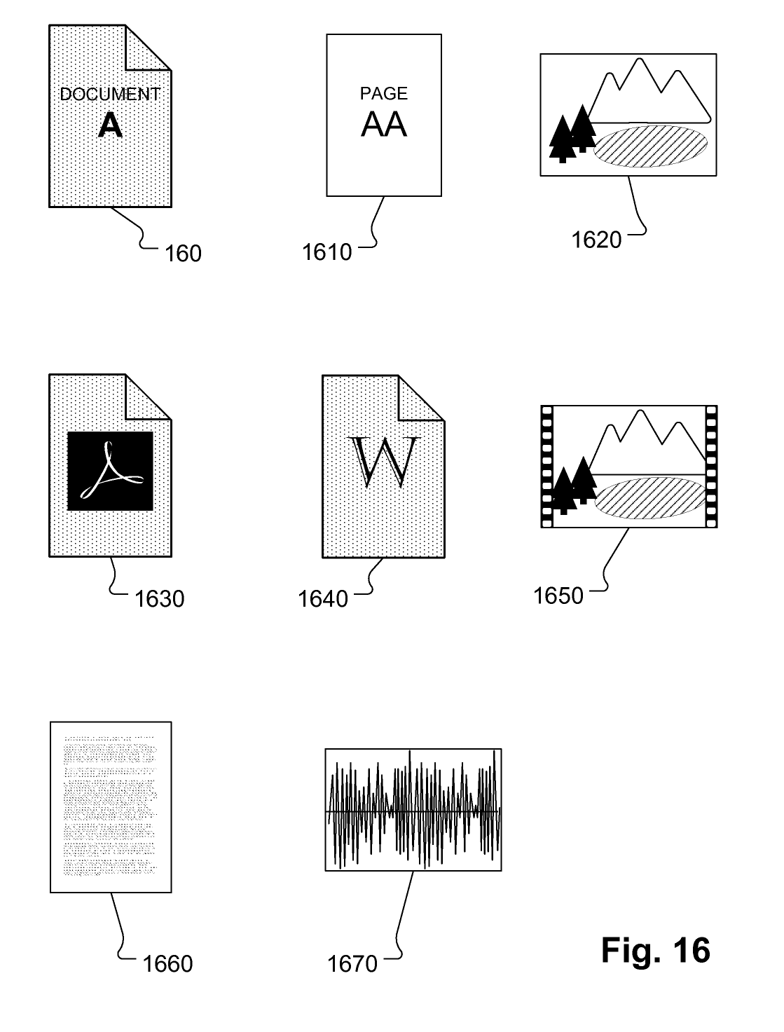

FIG. 16 illustrates several possibilities for icons to be used as graphical representations for items.

Icons 1600, 1630, 1640 indicate that the object referenced by the item is a document. Icon 1600 gives textual information to further specify the referenced document, such as, but not limited to, a document name or tags associated with the document. Icons 1630 and 1640 give an indication of the document type through the use of a logo. Here these logos are indicating an application that is used to edit or display the document.

Icons 1610 and 1660 indicate that the referenced object is a page. Icon 1610 gives textual information to further specify the referenced object, such as, but not limited to, the name of a document the page forms a part of or the page number. Icon 1660 displays a thumbnail image of the page.

Icons 1620, 1650 and 1670 indicate that the object referenced by the item is a media object. Specifically, icon 1620 indicates that the object referenced by the item is a picture, icon 1650 indicates a video file and icon 1670 an audio file. The representations of icons 1620, 1650 and 1670 may be general icons that only generally indicate the object type referenced. They may also be representations that are connected to the actual file content. Icon 1620 may be a thumbnail image of the entire referenced image or a part thereof. Icon 1650 may be a thumbnail image of a still image from the referenced video object. 1670 may be a graphical representation of a part of the actual waveform of the audio file.

It should also be appreciated that icons may contain combinations of indicators, e.g. be a thumbnail image of a document page with a text overlay. It will further be appreciated that other graphical aspects of an icon may be used to give additional indications about the objects referenced by an item, such as, but not limited to, the color of the entire icon and the color of parts of the icon. The graphical display of the icon need not be static. Effects such as, but not limited to, color cycling, blinking and animated elements, such as, but not limited to, fading in and out of parts of the icon, or rotation or other animation of the icon or icon elements, may be used. The graphical content of the icon may further change dynamically, such as, but not limited to, an icon for an item referencing a video object showing a part of the video, the waveform of an audio file scrolling through the area of the icon and thumbnails of the pages of a document being paged through.

Further graphical indicators may be external to the icon, such as, but not limited to, a change in the background color of the view immediately surrounding the icon, and text or additional graphical elements adjacent to an icon.

Indicators may also include audio clues such as, but not limited to, audio signals specific to document types or the text-to-speech transformation of document content or metadata under conditions such as, but not limited to, when a document first enters the displayed area of a view or receives the program focus.

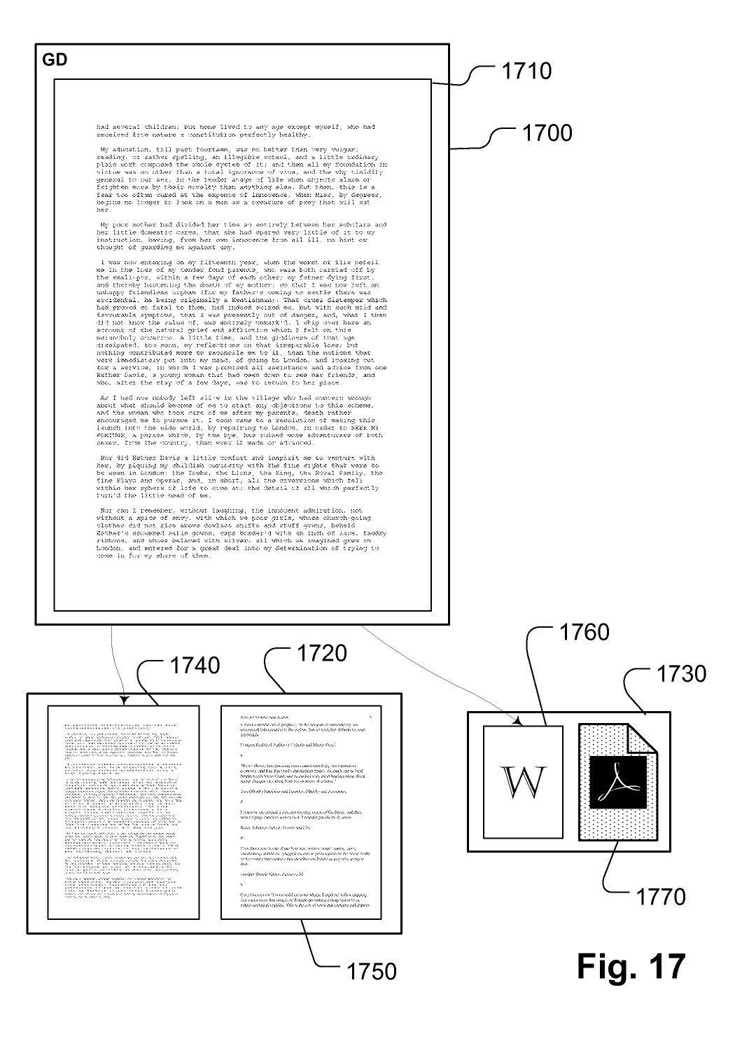

In FIG. 17 object 1700, which contains page 1710, is referenced by items in both view 1720 and 1730. In view 1720, the icon for item 1740 referencing 1700 is a thumbnail of page 1710. In view 1730, the icon for item 1760 referencing indicates that 1700 is a word-processing document or may be displayed or edited through the use of a word-processing application.

Note that while in view 1720 the icon for Item 1750 also shows a thumbnail, just as does the icon for 1740, and both items in 1730 are also represented by a similar type of icon, different types of icons may be used in the same view.

### Graphical Display of Views

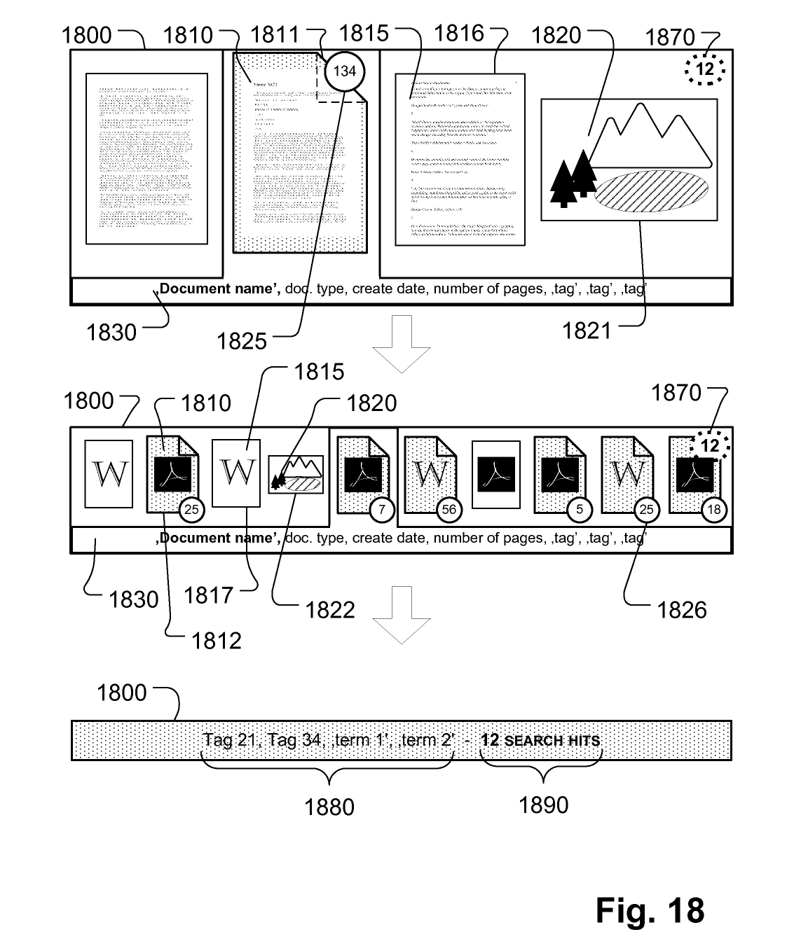

FIG. 18 shows several different displays of a view.

In the first perspective of FIG. 18, view 1800 is has a relatively large height compared to its width. The icons for the items are in the form of thumbnails of the objects, or part of the objects, referenced by the items, such as the first page of a referenced document in icon 1811 for item 1810, the contents of a referenced page in icon 1816 for item 1815, and a thumbnail of an image in icon 1821 for item 1820. Depending on the screen size and the size of the viewport, these thumbnails may enable the user to get anything from a feel for the contents of an object referenced by an item, such as being able to make a distinction between a business letter and an advertising brochure, to being able to distinguish sufficient details of the object content that opening the object in a viewer may be unnecessary in a lot of cases.

Below the icons for the items there is an information area 1830, which is graphically connected to an item it provides information about. Information provided here may be, as illustrated, and for an item that references a document, metadata such as, but not limited to, a document name, document type, creation date of the document, number of pages and tags assigned to the document. It may additionally be other information, such as, but not limited to, a date the document was added to the object collection, the creator of the document, a processing state for the document, a number of times the document has been accessed, a number of times the document has been edited, a number of other documents that reference this document,

For other object types referenced by an item, other types of information may be displayed. For e.g. a photographic image such information could be, but is not limited to, the place the photographic image was taken, the camera model and lens used, the camera settings and processing steps applied to the image.

The selection of the item the information area displays information about may be program-controlled and/or user-controlled. The selection could depend on a direct user-selection, such as, but not limited to, the user tapping on an item's icon, or through an indirect user-selection, such as, but not limited to, the user scrolling a view and information being displayed about an item currently occupying a specific position in the view, such as the left-most item to be fully displayed. A program-controlled selection might be, but is not limited to, each item in a view being selected in sequence and its information being displayed in the information area for a preset time period in an overview mode for a view, or the view scrolling and the selection shifting to an item that best fulfills current search criteria.

Information about items or an object referenced by them may additionally be display in other parts of the view. In the top view of FIG. 18, there is a display 1825 of the number of pages the document referenced by item 1810 contains, in the form of a circle containing said number displayed overlapping with the top right corner of the icon 1811 for item 1810. Such display may be only for the item for which information is displayed in the information area 1830 or for all items for which such information is pertinent. The display of information about items may be changed dynamically depending on factors such as, but not limited to, the search used to populate the current view, the user interaction history for the current view and user selection of information to display.

Information about the total number of items in the view is here displayed in the upper right corner. Additionally, other information pertaining to the view as a whole may be displayed, such as, but not limited to, any search terms used in a search that populated the view, a breakdown of the types of objects referenced by the items in the view, and the number of items already accessed from the view.

In addition to elements displaying items, views may contain additional elements such as, but not limited to, scroll controls, controls to call up a context menu for the view, controls for starting a search to populate or modify the view, and controls for ordering the items in a view according to predefined criteria, such as, but not limited to, date created, object type, order in which they were added to the view, whether they have already been accessed from the view, and relevance to a search as determined by an application displaying the view.

These and any other elements, may also be presented to the user in the form of a context menu for the view. Such a menu could contain both elements pertaining to the view it is accessed from and global elements for the application displaying the view. The context menu could be evoked mean such as, but not limited to, a mouse right-click while the mouse pointer is within a view, a gesture on a touch screen, a dedicated on-screen control element and a dedicated hardware key.

In the second perspective of FIG. 18, view 1800 is adjusted so that it has a smaller height relative to its width compared to its display in the top perspective. The icons for the items display a graphical indication of the type of object referenced. While here only graphical indicators for Adobe PDF documents (1812), Microsoft Word documents (1817) and image files (1822) are shown, it will be appreciated that many other object types may be graphically represented. In addition to a graphical indication of the object type, there is an indication of the number of pages, such as 1826, for items which reference multi-page documents. While the information area 1830 is displayed as unchanged from the first perspective, it will be appreciated that this may adjust as well when other aspects of the view are changed. Such adjustment may include, but is not limited to, the size of the information area, the size of a font or fonts used for display of textual information, the amount of information displayed and the types of information displayed.

In the bottom perspective of FIG. 18, there is no display of individual items in view 1800. The bottom perspective of FIG. 18 shows view 1800 with a display of the information 1880 about a tags and search terms that were used in a search that populated view 1800, and additionally a display 1890 of the number of search results said search yielded. It will be appreciated, however, that other information about the view may be displayed, such as, but not limited to, a title of the view, either program-created or user-assigned, the create date and time of the view, the number of times a view has been accessed and the types of items contained in the view. The display of such information may be in textual form, in the form of icons or other graphical indicators where appropriate, or a mix of both. Such a reduced display as in the bottom view of FIG. 18 may e.g. be employed to display a large number of views at once to enable quick reordering of the views in an arrangement which is a stack of views.

### Arrangements of Views

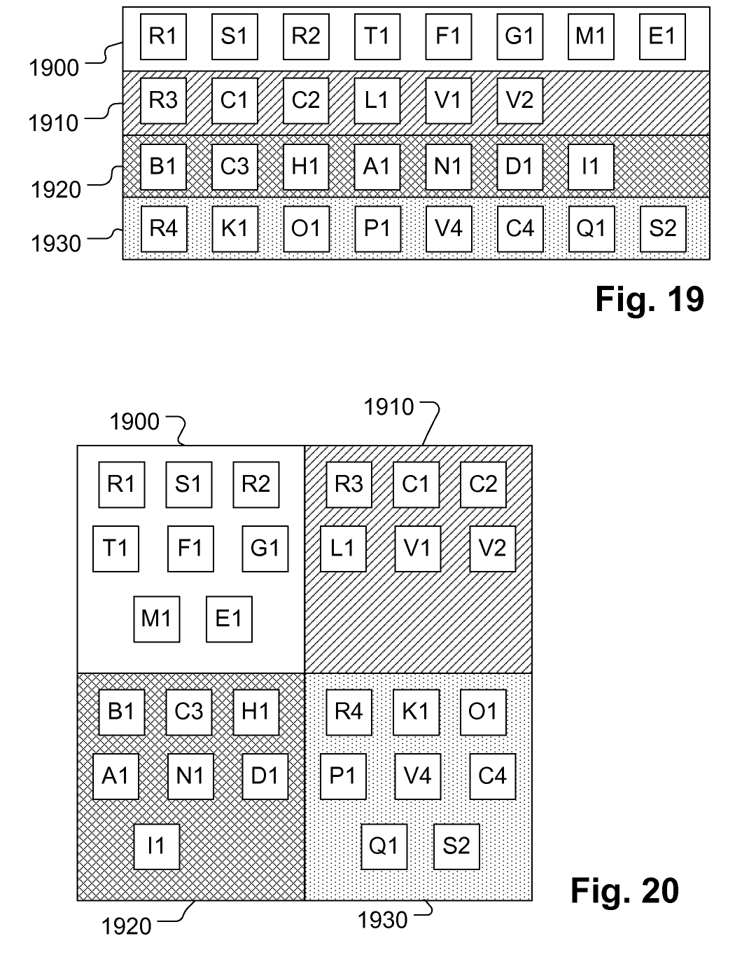

In FIG. 19, an arrangement of views is shown. The arrangement in FIG. 19 consists of four views 1900, 1910, 1920, 1930, which here are in the shape of horizontal bands and are arranged in a stack.

In FIG. 20 another arrangement of the four views 1900, 1910, 1920, 1930 is shown. Here the views have a square form and are arranged adjacent to each other so as to form a larger square.

In the arrangements of views illustrated in FIG. 19 and FIG. 20, the views have a fixed position relative to each other, i.e. any movement of the views occurs as a whole.

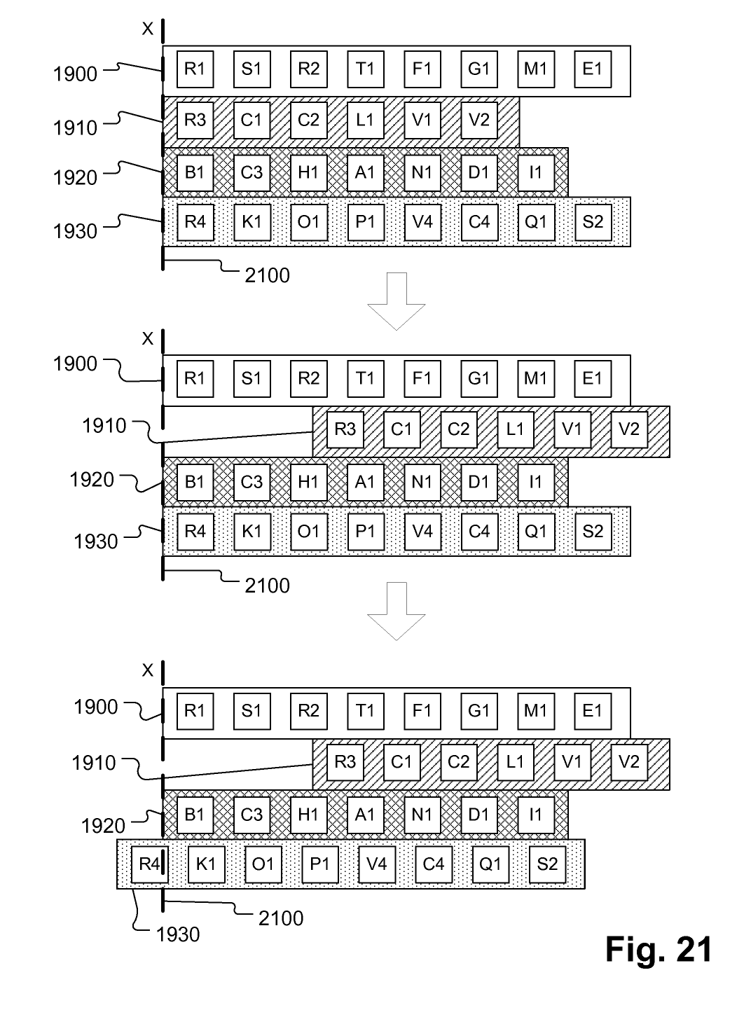

FIG. 21 illustrates an arrangement of views. The four views 1900, 1910, 1920, 1930 are in the shape of bands and are arranged as a stack. In the middle perspective of FIG. 21, view 1910 has been moved relative to views 1900, 1920, 1930. While the left borders of views 1900, 1920, 1930 are still at a horizontal position X (indicated by 2100), view 1910 now has a positive value horizontal position relative to X. In the bottom perspective of FIG. 21, view 1930 has been moved relative to views 1900, 1910, 1920, with view 1910 retaining its position from its previous move. View 1930 now has a negative value horizontal position relative to X.

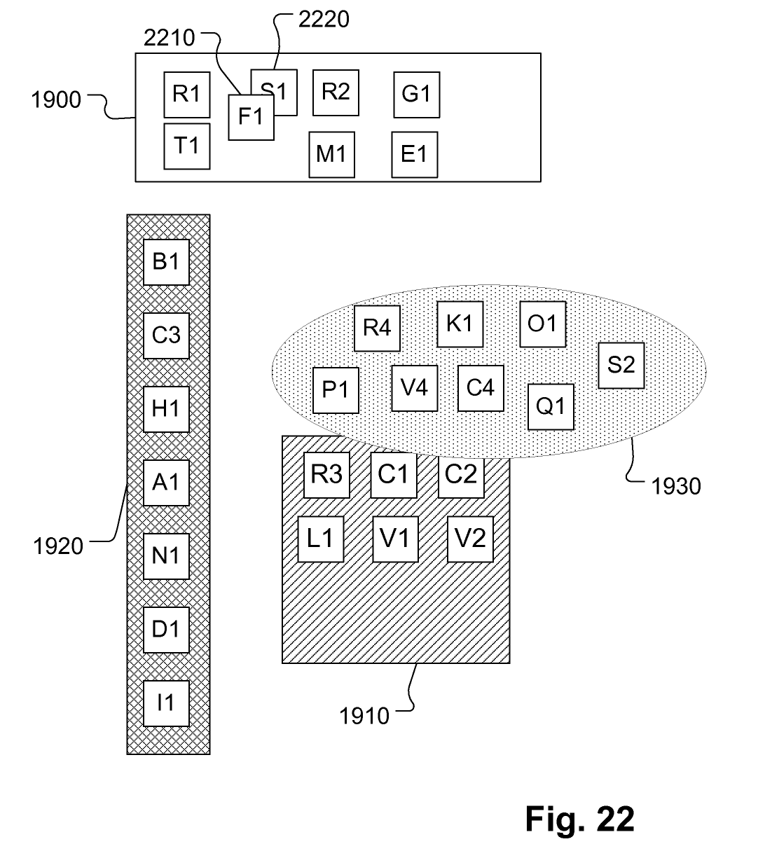

FIG. 22 illustrates an arrangement of four views 1900, 1910, 1920, 1930. Here each of the views has a different shape. Their arrangement is such that views 1900 and 1920 each do not adjoin other views, while views 1900 and 1930 partially overlap. An arrangement such as this might e.g. in a windowing environment where the views may be overlying other windows and can be arranged to enable the user to access both the views and the content of these other windows.

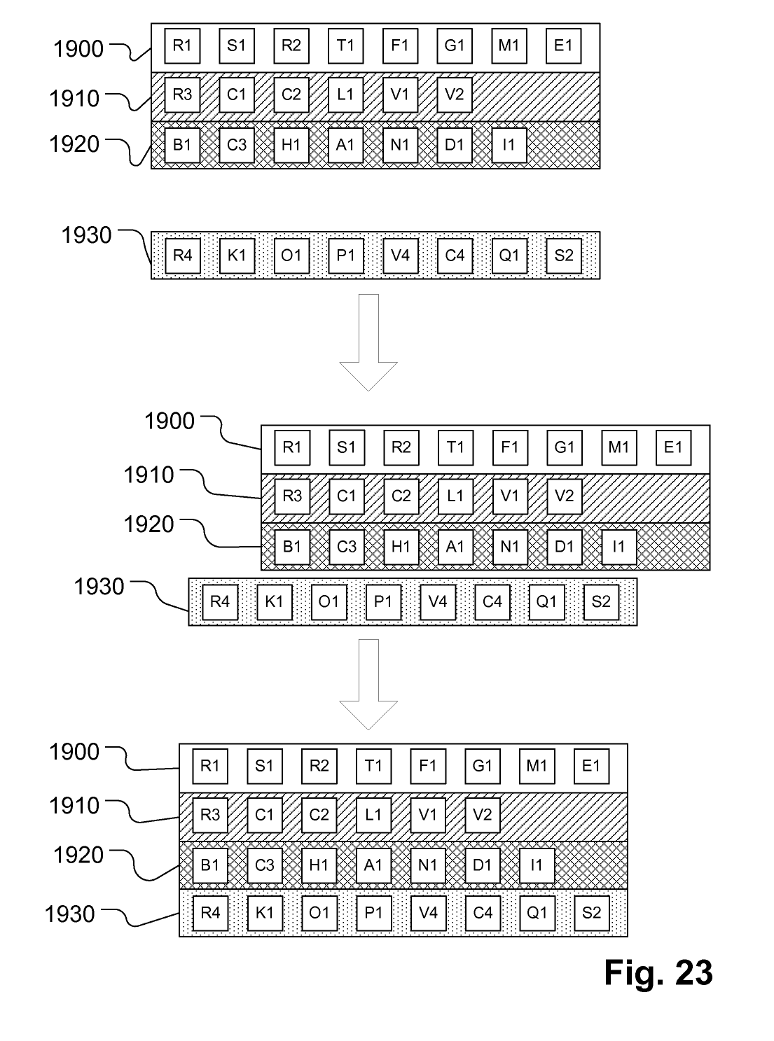

FIG. 23 illustrates an arrangement of four views 1900, 1910, 1920, 1930. In the first perspective of FIG. 23, three of the views, 1900, 1910 and 1930, are adjacent to each other, while view 1930 is non-adjacent to any of the three. In the middle perspective of FIG. 23, the three adjacent views 1900, 1910 and 1920 have been moved downward and to the right. Movement of the three views occurred together through a single user input, i.e. the three views may be said to be ‘docked’ to each other. The distance between the three ‘docked’ views 1900, 1910, 1920 and the single view 1930 has been reduced and is now quite small. The bottom perspective of FIG. 23 illustrates the effect of this distance between a ‘docked’ set of views and a single view, or other ‘docked’ set of views, falling below a threshold value. View 1930 has now been ‘docked’ to the other views 1900, 1910, 1920 without any further user input, based solely on the distance between view 1930 and the docked group of views 1900, 1910, 1920 being below such a threshold value. Further movement of view 1930 is now together with movement of views 1900, 1910, 1920 as a whole.

It will be appreciated that other shapes of views are possible. It will further be appreciated that the items contained in a view may be arranged in various ways, including, but not limited to, in a grid pattern, in other patterns that ensure equal distribution within a view and user defined. Item positions may generally be restricted to certain positions that conform to a pattern, be dynamically adjusted by the program, or be wholly free. Items may also overlap, such as in FIG. 22 in view 1900 items 2210 and 2220.

It will also be appreciated that the views as displayed in an arrangement may be of a size that is determined by the arrangement or by factors such as, but not limited to, the largest size of a view in an arrangement, said largest size determined by the dimensions necessary to display all content of the view, or by the size necessary for each view to display all content of the view.

### Display in a Viewport

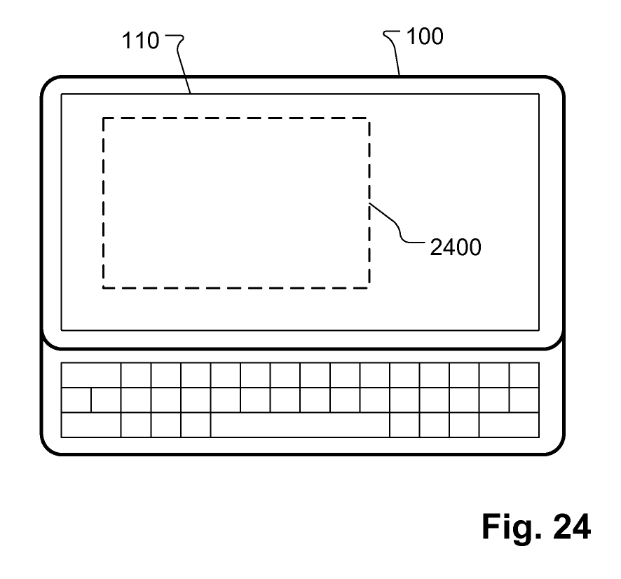

FIG. 24 shows a computing device 100 with a display 110 and a viewport 2400. The viewport 2400 is an area on the display 110 and may be smaller than the size of the display 110. The viewport defines a viewport coordinate system to which the world coordinates of content to be displayed in the viewport are translated. The viewport further occupies a certain space in the display coordinate system when and to the extent that it is displayed, and the viewport coordinates are then translated to display coordinates. While here a viewport is shown having a rectangular shape and extending further horizontally than vertically, it will be appreciated that other proportions and shapes are possible for a viewport.

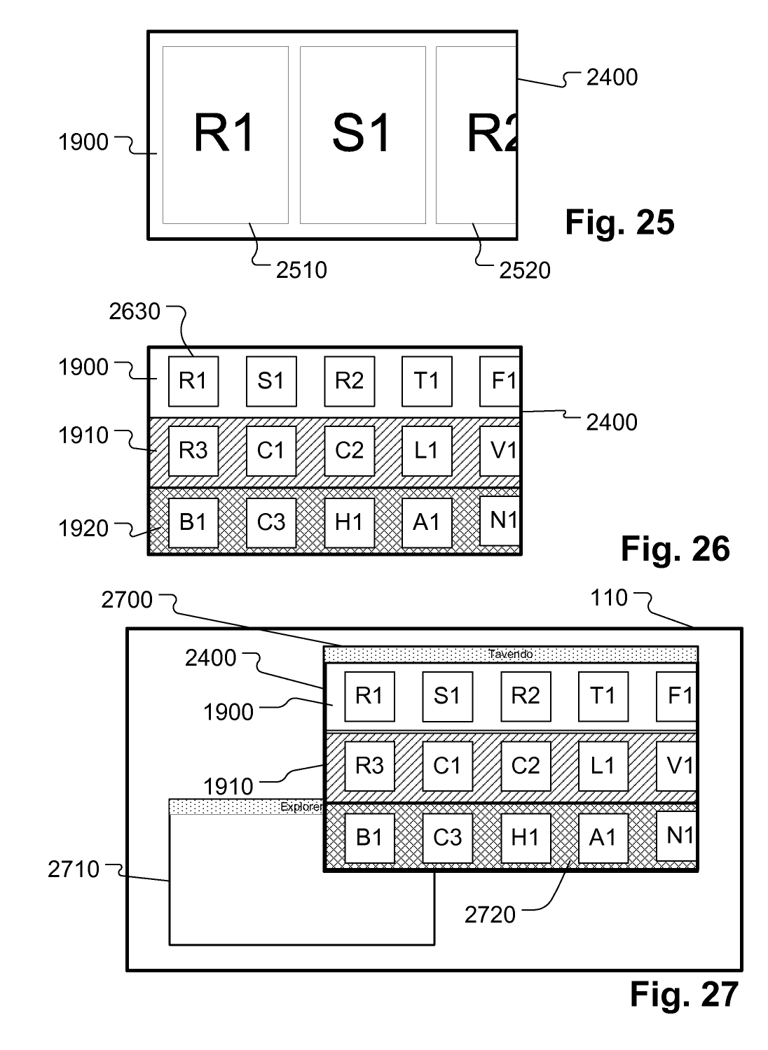

A view need not be displayed on a screen or in a viewport in its entirety. FIG. 25 shows a single view 1900 that is displayed in a viewport 2400. It is displayed fully in its vertical extent, but only partially in its horizontal extent. Item 2510 is fully displayed, while item 2520 is only partially displayed. The partial display of item 2520 indicates to the user that view 1900 extends to the right beyond the viewport 2400. There is, however, no indication whether it also extends to the left beyond the viewport. Regarding this, as well as in, but not limited to, cases where there are only fully displayed items visible within the viewport, graphical indicators may be used to alert the user to the fact that the view extends beyond the viewport. These indicators may be ones such as, but not limited to, arrows placed near a border of the viewport beyond which the view extends or a graded coloration of the background of the view near such a border.

FIG. 26 illustrates the arrangement of views from FIG. 19 displayed in a viewport 2400. Views 1900, 1910 and 1920 are displayed fully in their vertical extent, while view 1930 is not displayed. The views extend beyond the right border of the viewport.

FIG. 27 shows a viewport 2400 with the displayed content as in FIG. 26, said viewport being displayed in a window 2700. The window 2700 is displayed together with another window 2710 on a display 110. Such display may be, but is not limited to, as part of a standard windowing system, where window 2700 is an application window, or within an application, where the entire display is managed by the application and both window 2700 and 2710 are part of the application.

It will be appreciated that while here only views are shown as elements of a display, other elements may be added to the display. Such elements may be, but are not limited to, menu bars, control elements such as on-screen buttons, and viewers displaying the content of an object or part or parts thereof.

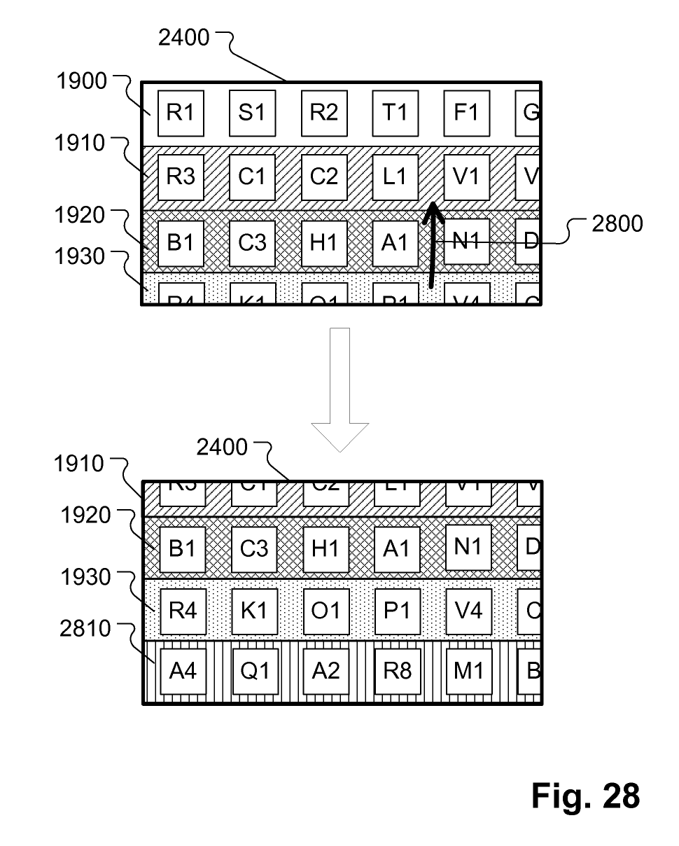

FIG. 28 illustrates vertical scrolling of an arrangement of views in a viewport 2400. In the top perspective of FIG. 28, views 1900, 1910, 1920 and 1930, which are arranged in a stack, are partially displayed in a viewport 2400. In the bottom perspective the stack of views has been displaced upwards. View 1900 has been displaced beyond the upper border of viewport 2400 and is no longer visible, while view 2810 is now within viewport 2400 and is displayed.

Scrolling here was effected through a user input 2800, which is an upward swipe on a touch screen. The way such a swipe is effected may depend on the kind of touch screen provided by a computing device, and may include a user touching the touch screen using his finger and the user employing a stylus on the touch screen. It will be appreciated, however, that other user input may also effect such scrolling or be used to control other program display of views. This includes, but is not limited to, pointer input via mouse, touchpad, track point, digitizer pen or other pointing device and keyboard input.

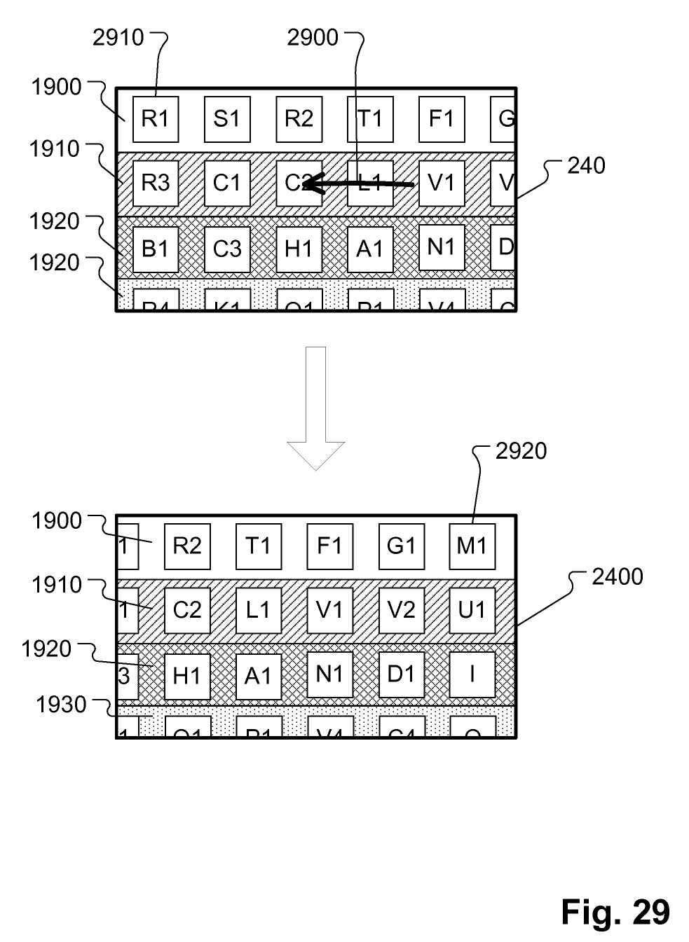

FIG. 29 illustrates horizontal scrolling of an arrangement of views in a viewport 2400. In the top perspective of FIG. 29, views 1900, 1910, 1920 and 1930, which are arranged in a stack, are partially displayed in a viewport 2400. In the bottom perspective the views have been displaced to the left. Items such as 2910 have been displaced beyond the left border of viewport 2400 and are no longer visible, while items such as 2920 are now within the viewport 2400 and are now displayed.

Scrolling here was effected through a user input 2800, which is a leftward swipe on a touch screen. It will be appreciated, however, that user input may also be interpreted to effect such scrolling, or be used to control other program display of views. This includes, but is not limited to, pointer input via mouse, touchpad, track point, digitizer pen or other pointing device and keyboard input.

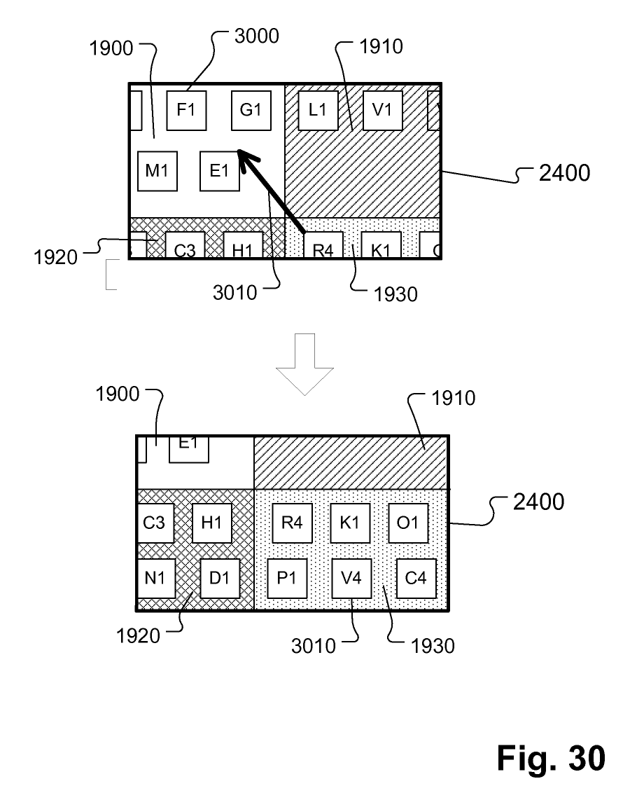

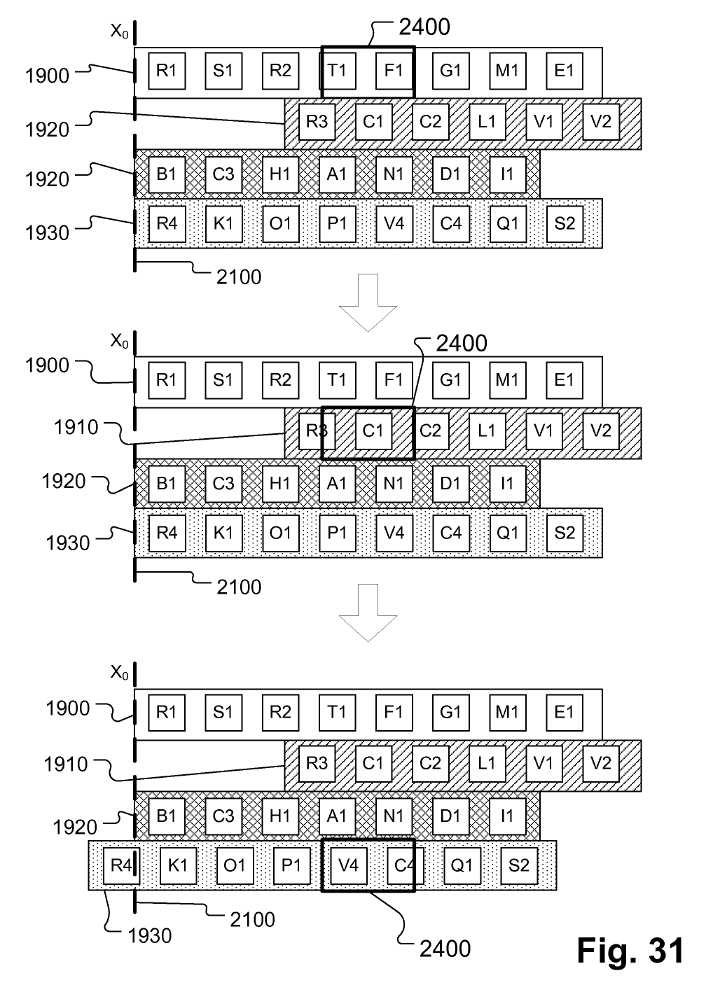

FIG. 30 illustrates panning of an arrangement of views in a viewport 2400, i.e. simultaneous vertical and horizontal scrolling. In the first view of FIG. 30, an arrangement of views in the form of tiled squares, comprising views 1900, 1910, 1920 and 1930, are partially displayed in a viewport 2400. In the second view the views have been displaced upwards and to the left. Items such as 3000 have been displaced beyond the borders of viewport 2400 and are no longer visible, while items such as 3010 are now within the viewport 2400 and are displayed.

Panning here was effected through a user input 3010, which is a leftward and upward swipe on a touch screen. It will be appreciated, however, that other user input may also be interpreted to effect such scrolling, or be used to control other program display of views. This includes, but is not limited to, pointer input via mouse, touchpad, track point, digitizer pen or other pointing device and keyboard input.

FIG. 31 illustrates moving a viewport on an arrangement of views. Here the arrangement is a stack of four bands 1900, 1910, 1920, 1930. In the top perspective, viewport 2400 is on view 1900. In the middle perspective viewport 2400 has been moved onto view 1910. While its vertical position has changed, its horizontal position relative to X₀ has remained the same. In the bottom perspective viewport 2500 has been moved onto view 1930, again retaining its horizontal position relative to X₀, and view 1930 has been scrolled to the left within the stack of views.

It will be appreciated that while here a relationship of viewport size and view size is shown where only a single view fits within the viewport at a time, in embodiments this relationship may be chosen so that more than one view can be displayed.

It will further be appreciated that scrolling or panning of an arrangement of views may be program-controlled additionally to being user-controlled. Such program-control may include, but is not limited to, scrolling or panning when the dragging of an item or a view nears the border of a viewport displaying said arrangement, in order to show newly added content to the user, in order to keep an item that is currently in focus displayed in a viewport when the contents of a view are reordered according to a new ordering criterion, and in order to display items that contain search hits for a search conducted by the user on the items within a view.

### Panning a View

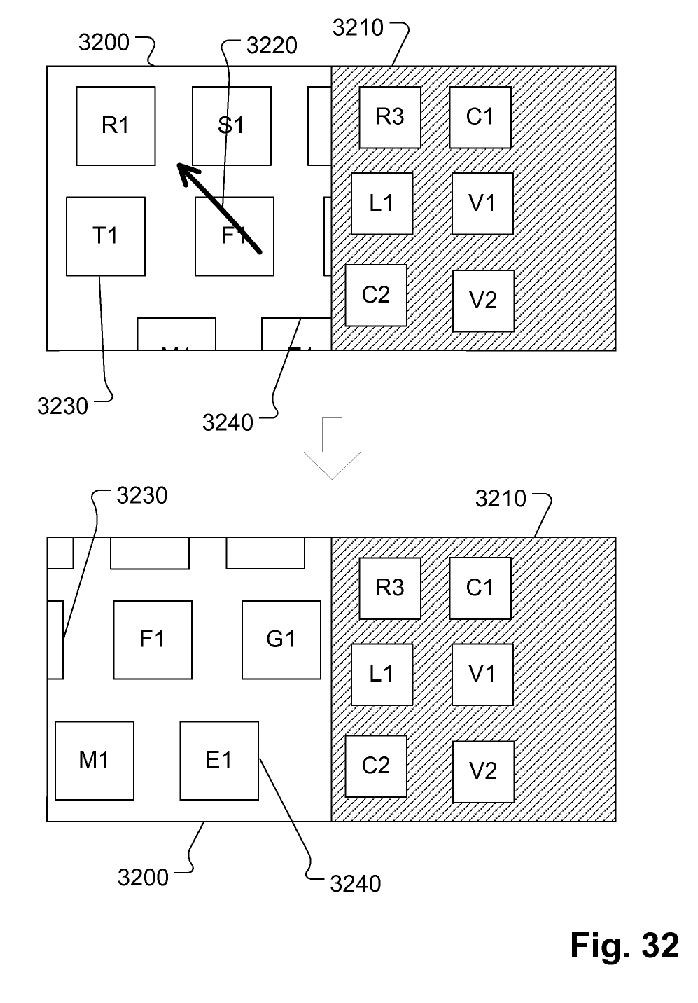

FIG. 32 illustrates panning a view within the area of its graphical display in an arrangement. Whereas the entire content of view 3210 is displayed, more content and a different display size for the items in view 3200 means that only part of its content fits into the display area it has on screen. In the bottom perspective of FIG. 32, view 3200 has been panned upwards and to the left, and elements such as 3230 that were previously fully displayed are now partially hidden, while elements such as 3240 that were partially hidden are now fully displayed. In this way, a view may have a size that is bigger than its display area.

Panning here was effected through a user input 3220, which is a leftward and upward swipe on a touch screen. It will be appreciated, however, that other user input may also be interpreted to effect such scrolling, or be used to control other program display of views. This includes, but is not limited to, pointer input via mouse, touchpad, track point, digitizer pen or other pointing device and keyboard input.

Other controls for scrolling and panning in addition to or instead of direct scrolling may be employed here and wherever else scrolling and/or panning are employed in an embodiment. These include, but are not limited to, scroll bars and scroll keys.

To distinguish user input that effects panning of a view within the area of its graphical display from user input that effects panning of an arrangement of views, and from user input that effects the movement of a view relative to other views in an arrangement, additional input, such as but not limited to, the pressing of hardware controls and a previous mode switch, may be required, aspects of the input such as, but not limited to, pressure may be interpreted to distinguish between the different kinds of panning and movement, and on-screen controls such as, but not limited to, scroll bars and on-screen buttons may be employed. For example, swiping on a view might scroll the view, while the same gesture executed while a hardware control button is pressed simultaneously may result in the view being moved to a new position with an arrangement of views.

### Moving a View

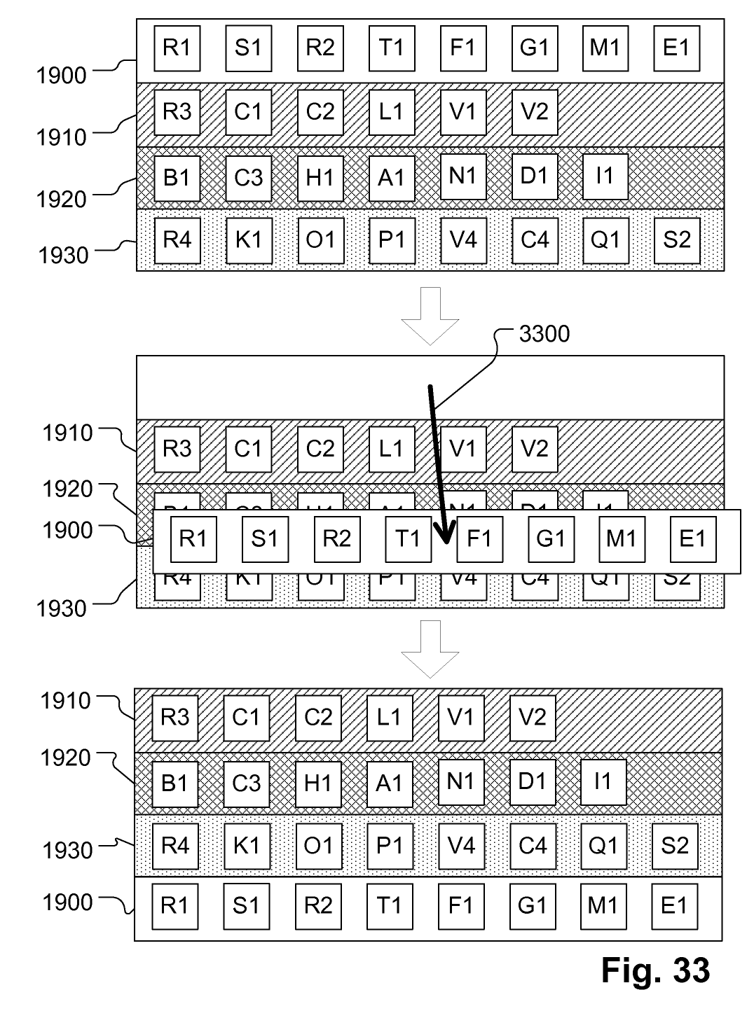

FIG. 33 illustrates moving a view within an arrangement of views. The top perspective of FIG. 33 shows a stack of four views, 1900, 1910, 1920, 1930. In the middle perspective of FIG. 33, view 1900 has been dragged from its initial position at the top of the stack of four views and it has been dragged downwards and slightly to the right. The space at the top of the stack, which 1900 used to occupy, is presently empty. In the bottom perspective of FIG. 33, view 1900 is in a new position at the bottom of the stack, in the position formerly occupied by 1930. Views 1910, 1920 and 1930 are now at new positions, where 1910 is now at the position formerly occupied by 1900, 1920 is now at the position formerly occupied by 1910, and 1930 at the position formerly occupied by 1920.

When reference is made here to ‘dragging’, this not only refers to the dragging in a common windowing environment and using a pointing device with an additional hardware control button, i.e. the user action of selecting an item with a pressing of a selector button of a pointing device and displacing it using said pointing device while the selector button is being kept pressed, but rather to any user input that effects the displacement of an object. This may include, but is not limited to, selection via a pointer down and movement via a pointer move on a touch screen, selection via a button click, displacement via the pointing device and clicking again to drop, and the use of a regular keyboard to effect selection and displacement.

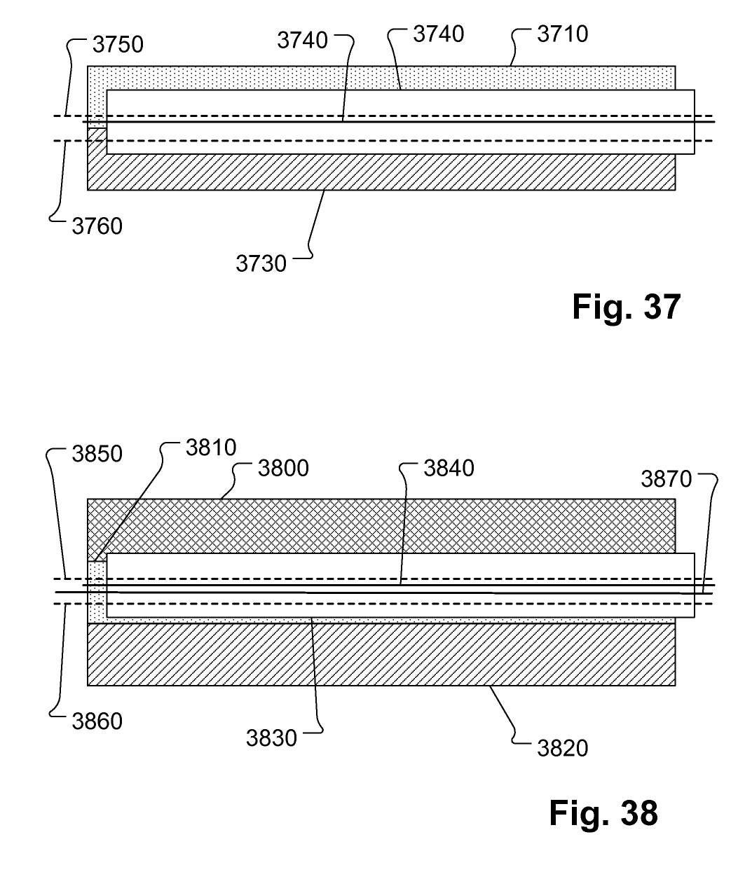

In some embodiments the view whose position is changed, such as 1910 here, may be displayed as overlying other views such as 1910, 1920, 1930 while traversing them, and only be displayed in its new position once a certain ‘snap-in’ condition (an instance of which is described further on in connection with FIG. 37) has been fulfilled. However, other ways of indicating its change of position may be employed, such as, but not limited to, the view successively changing position with each view directly below during an downward movement and above during an upward movement. This change may be tied to a certain distance of pointer movement, a threshold overlap value or some other condition.

Similarly, the other views changing position as result of the moved views new position, such as here 1920 and 1930, may be graphically displayed to ‘slide’ upwards into their new positions dynamically or once it is determined that the moved view, such as here 1910, will be positioned in a new position, but other ways of indicating their change of position and displaying them at their new position may be employed. These may be, but are not limited to, the views fading from their original position and fading in at their new position.

It will be appreciated that moving views is not limited to arrangements of views in the form of a stack, such as displayed in FIG. 33. In an embodiment such as the one shown in FIG. 20, and for movements that do not occur within either a row or a column of tiles, other rules need to be employed. For an arrangement of views such as the one shown in FIG. 22 movement need not be restricted at all, as indicated by the overlap between views 1920 and 1930, or rules to avoid such overlap by shifting other views may be implemented.

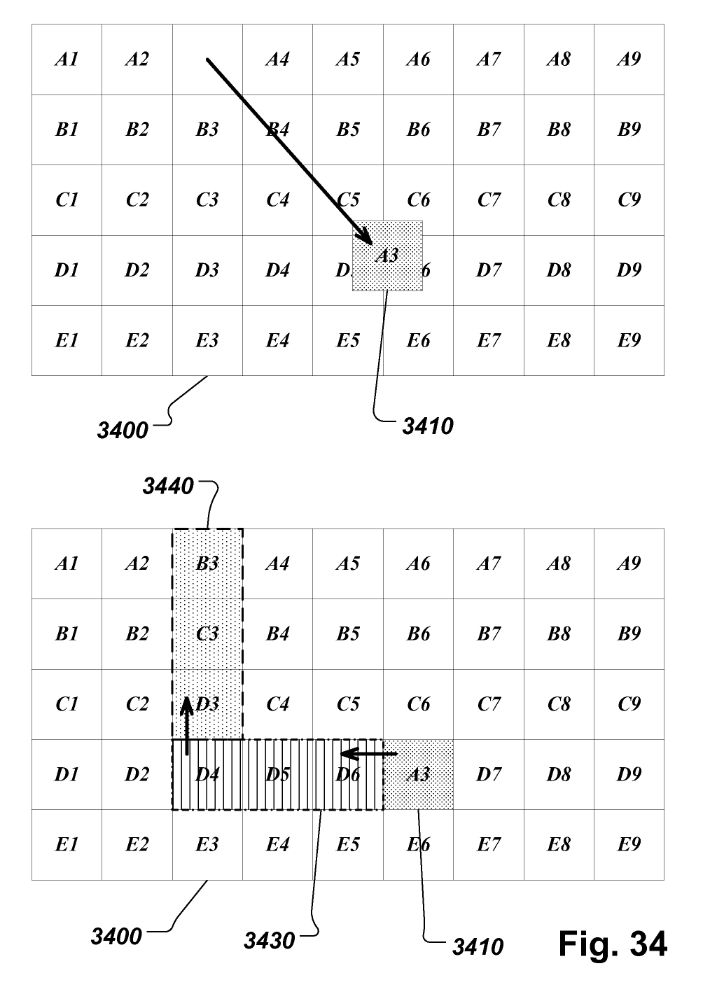

FIG. 34 illustrates such a rule for an arrangement of views in the form of a grid. In the top perspective, view 3410 has been moved from its initial position. In the bottom perspective, view 3410 is at its new position. The vertical group of views 3440 has been moved upward and the horizontal group of views 3430 has been moved to the left, to free up the new position for view 3410 and to fill the old positions.

It will further be appreciated that while here only the movement of a single view is shown, in some embodiments several views may be moved simultaneously after a selection of such several views by the user. Movement here may be with all selected views grouped together and positioned together at the end of the move, or with the selected views keeping their relative positions.

### ‘Dropping a View’

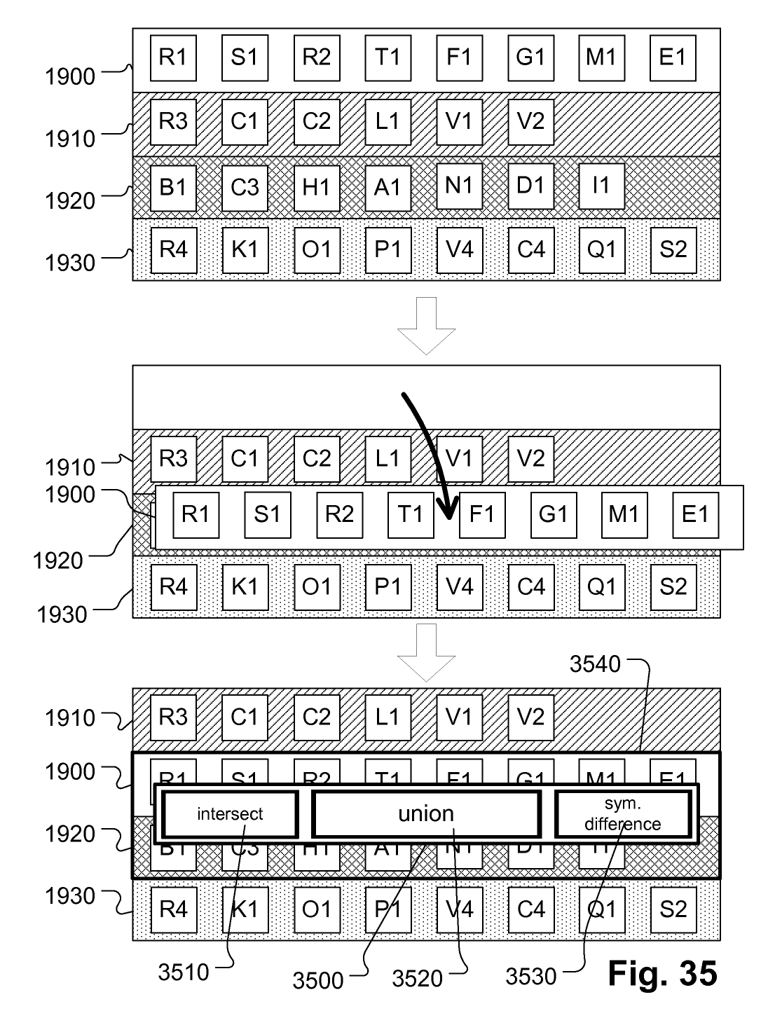

FIG. 35 shows an interaction initiated by ‘dropping’ a view onto another view. The top perspective of FIG. 35 shows a stack of four views, 1900, 1910, 1920, 1930. In the middle perspective of FIG. 35, view 1900 has been moved downwards and slightly to the right. In the bottom perspective of FIG. 35, view 1900 has been dropped onto view 1920. As a result views 1900 and 1920 are now displayed adjacent, with a bold line 3540 surrounding both, indicating that an action may be executed using both views as sources, and with a menu 3500 overlaying the two views that includes one or more user-selectable commands. The menu 3500 contains one or more commands that, if selected by the user, implement corresponding actions regarding the two views, which here are ‘intersect’ (3510), ‘union’ (3520) and ‘sym. difference’ (3530). Upon user selection of an action, the action is executed with both views as sources. User action to select from the menu may be, but is not limited to, any of the commonly used ways of selection, such as a tap on a touch screen, a mouse click, a tap on a touch pad and a key press.

It will be appreciated that while here only two views as sources for an action are illustrated, more views may be used. This may be accomplished through user actions or mechanisms such as, but not limited to, not selecting an action from a menu such as 3500 when it is first displayed, but to continue to drop views onto the views already selected for the action until all the desired views have been added, and then execute the action on the entire group, and to select all but one desired views to move and drop onto the remaining desired view at once.

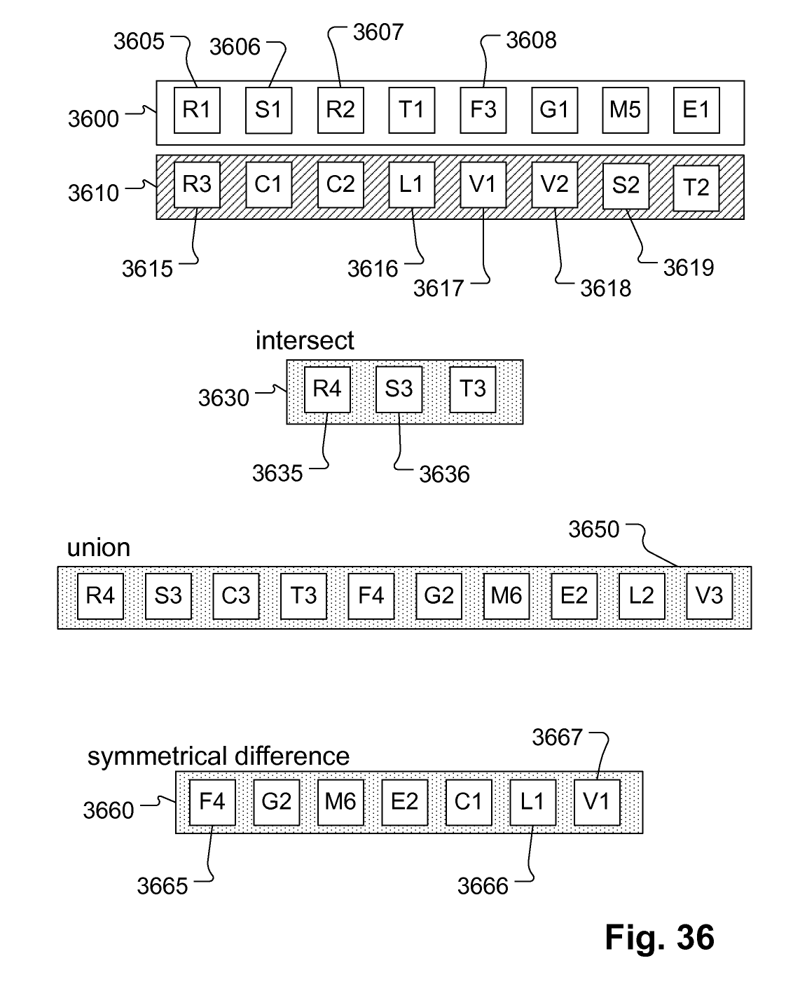

FIG. 36 illustrates several possible results for actions to be performed when a view has been dropped onto another view. Here the actions are performed using views 3600 and 3610, shown at the top of FIG. 36, as sources.

View 3630 illustrates the result of intersecting views 3600 and 3610. View 3630 contains items that reference objects which are referenced by items in both source views. For example the object referenced by 3635 is referenced by 3605 and 3607 in view 3600 as well as 3615 in view 3610, and the object referenced by 3636 is referenced by 3606 in view 3600 and 3619 in view 3610. Note that while here only one item referencing each of the objects which are referenced by items in both source views is created in view 3630, embodiments may implement creating one item per each item that references an object in the source views, or offer both variants for user choice.

View 3650 illustrates the result of a union of views 3600 and 3610. View 3650 contains items that reference all objects that are referenced by items in either source view. Note that while here only one item referencing each of the objects which are referenced by items in either source view is created in view 3650, embodiments may implement creating one item per each item that referenced an object in the source views, or offer both variants for user choice.

View 3660 illustrates the result of a symmetrical difference of views 3600 and 3610. View 3660 contains items that reference objects that are referenced by items in one and only one source view. For example the object referenced by item 3665 is only referenced by item 3608 in view 3600, while the object referenced by item 3667 is referenced by items 3617, 3618 in view 3610, but not by any item in view 3600. Note that while here only one item referencing each of the objects which are referenced by items in only one source view is created in view 3660, embodiments may implement creating one item per each item that referenced an object in the source views, or offer both variants for user choice.

In embodiments both source views may be deleted, the dragged view may be deleted, the drop target view may be deleted, or both source views may be retained. Which of these is executed may depend on additional user input when selecting an action to perform on the selected views, or at another time during the drag and drop action. If the source views are retained, then the dragged view may be placed adjacent to the target view and/or the resulting view, or be returned to its original position. The resulting view may for example be created next to the drop target view, or may be created ‘floating’, i.e. its position has to be determined by the user.

FIGS. 37 and 38 illustrate a selection logic between snapping a view into a new position and detecting that a view has been ‘dropped’ onto another view.

In FIG. 37, the horizontal center line 3740 of view 3720 is within a zone bordered by lines 3750, 3760, said zone being centered on the border between views 3710 and 3730. In this position of view 3720 a stop of the user input that drags view 3720 leads to view 3720 being placed in a new position between views 3710 and 3730.

In FIG. 38, the horizontal center line 3840 of view 3830 is within a zone bordered by lines 3850, 3860 and centered on the horizontal center line 3870 of view 3810. In this position a stop of the user input that drags view 3830 leads to a drop of view 3830 on view 3810 being detected.

### Deletion and Addition of Views

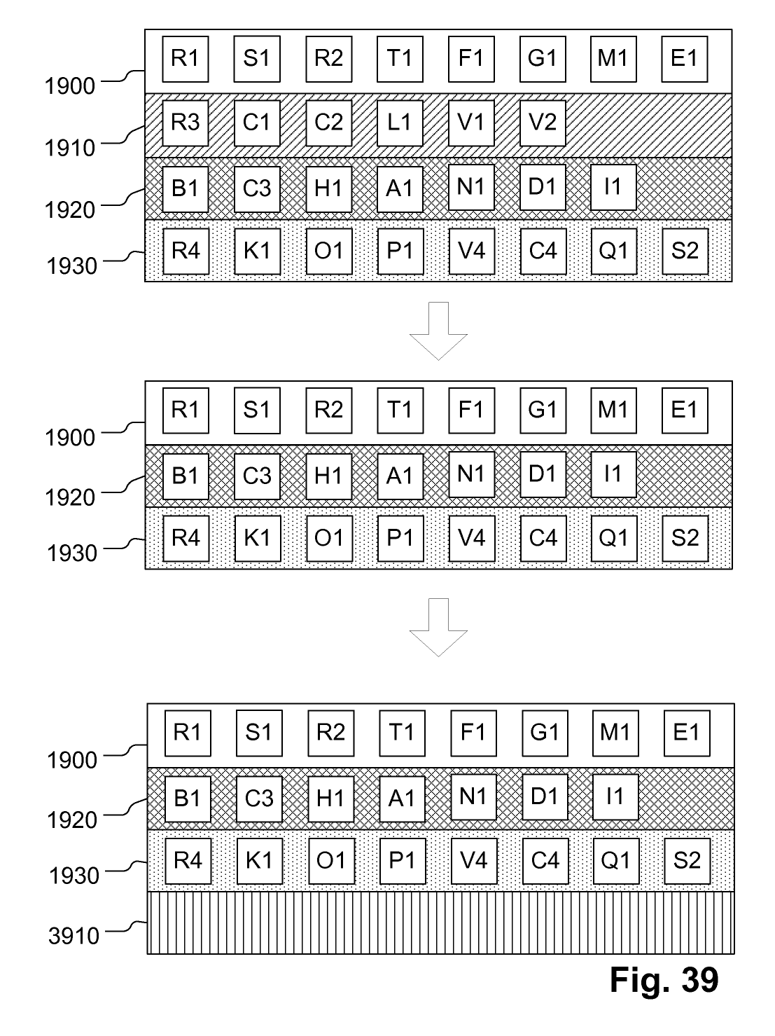

FIG. 39 shows the deletion of a view and the subsequent addition of a view to an arrangement of views. In the top perspective of FIG. 39 an arrangement of views in the form of a stack contains four views, 1900, 1910, 1920, 1930. In the middle perspective of FIG. 39 view 1910 has been deleted. Views 1900 and 1920 are now adjoining. In the bottom perspective of FIG. 39, view 3910 has been added to the arrangement of views, below view 1930 in the stack. View 3910 is presently empty.

Deletion of a view may be through user action such as, but not limited to, selecting a view with a pointing device and selecting ‘deletion’ as an action from a context menu for the view, and through an on-screen control button that offers one-click deletion. Addition of a view may be through user action such as, but not limited to, selection of a ‘create new view’ action from a context menu for a view, and a pointer gesture. Additionally deletion or addition of views may be program-controlled, such as, but not limited to, the deletion of a view from which all items have been moved.

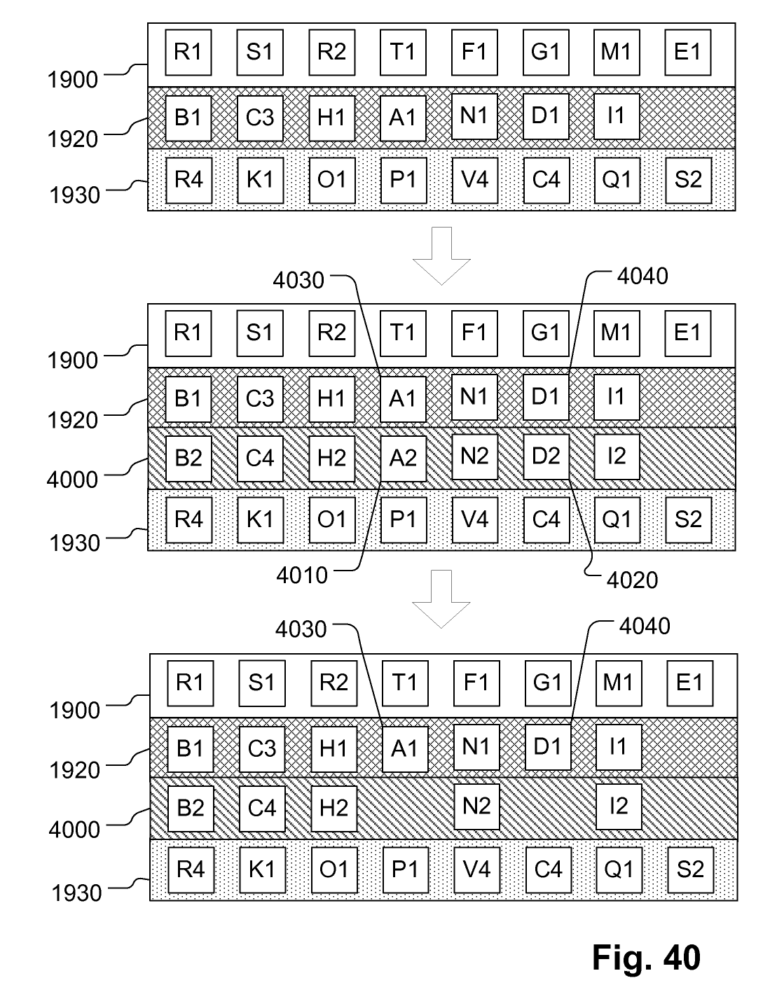

FIG. 40 shows adding a view to an arrangements of views through cloning of a view. In the top perspective of FIG. 40, the arrangement of views in the form of a stack contains three views, 1900, 1920, 1930. In the middle perspective of FIG. 40, view 4000 has been added. View 4000 is a clone of view 1920, i.e. it contains items referencing the same objects, such as 4010 and 4030, 4020 and 4040, and which are presently in the same order as in 1920. While the items in 4000 reference the same objects as the items in 1920, they differ first of all in that they are contained in different views, and may further differ in other respects, such as, but not limited to, their graphical representation. The bottom perspective of FIG. 40 shows items 4010 and 4020, referencing objects A and D in the object collection respectively, deleted from view 4000. The items 4030 and 4040 in view 1920 which reference the same objects have not been affected by this deletion.

### Flows of an Embodiment

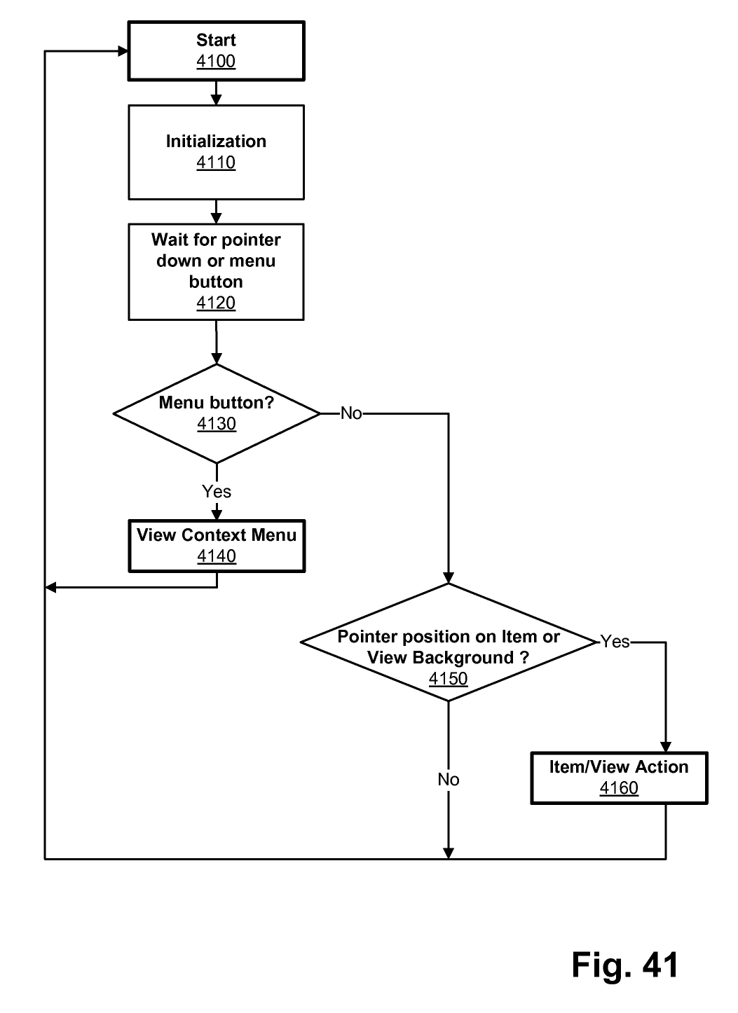

FIG. 41 illustrates a flow chart of a method in accordance with an embodiment in which the arrangement of views is a stack of bands. The flow starts 4100 with initializing 4110 the display of views. This initialization entails actions such as, but not limited to, loading or updating the arrangement that is displayed, including the views to be displayed, the items they contain and the positions the items and the views are to be displayed at, and the view currently in focus, and initiating a graphical display of the arrangement. The flow then waits 4120 for a pointer down event or a menu button selection. If a menu button selection is determined, then the viewing of the context menu 4140 is started. If no selection of a menu button is determined, then it is determined 4150 whether the pointer position of the pointer down event is on an item or on a view background. If it is determined 4150 to be on neither an item nor a view background, then the flow returns to the start 4100. If it is determined 4150 to be on either an item of a view background, then the item/view action 4160 is started.

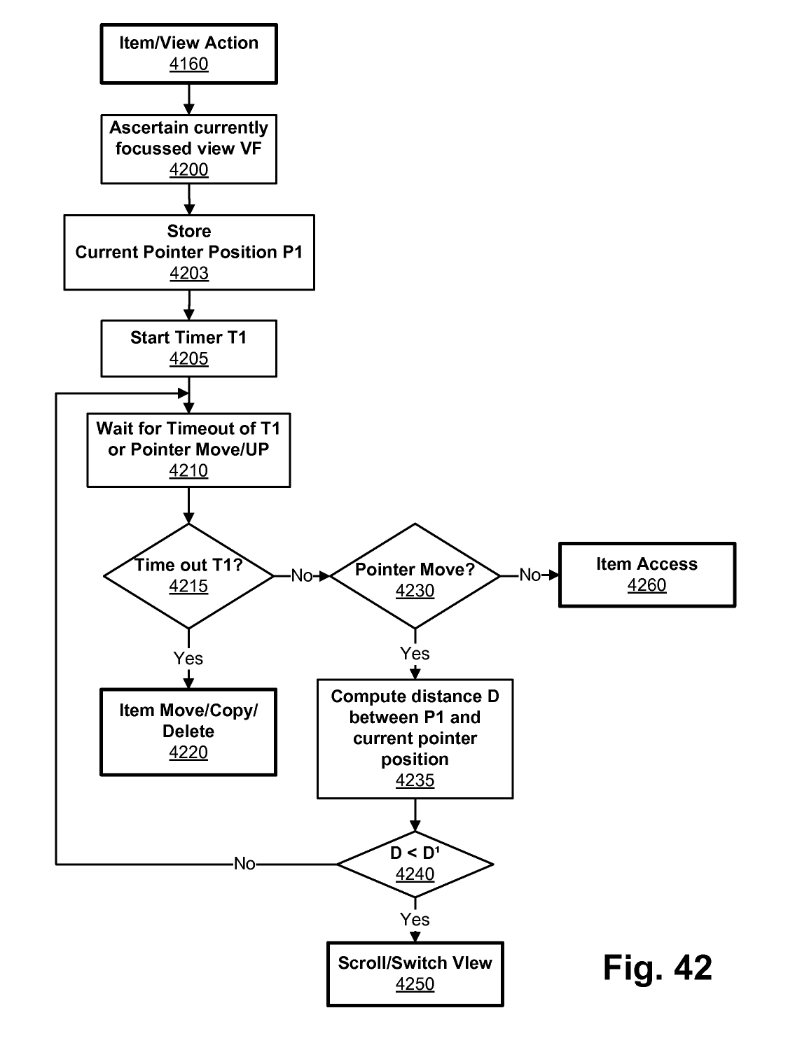

FIG. 42 is a flow of the determination of an item or view action. The flow starts by ascertaining 4200 the currently focused view VF. Then the current pointer position is saved 4203 as P1, and a timer T1 is started 4205. The flow then waits 4210 for the first of either pointer move/up or the time-out of timer T1. If timer T1 is determined 4215 not to have run out, then it is determined 4230 whether the pointer has been moved. If it is determined 4230 that the pointer has not moved, then item access 4260 is started. If the pointer is determined 4230 to have moved, then the distance between P1 and the current pointer position is computed 4235. If that distance is determined 4240 to be not larger than a threshold value D¹ the flow continues to wait 4210 for the first of either a pointer move/up or a timeout of T1. If the distance is determined 4240 to be larger than the threshold value D¹, then scroll/switch view 4250 is started. If it is determined 4215 that the timer T1 has run out, then item move/copy/delete 4220 is started.

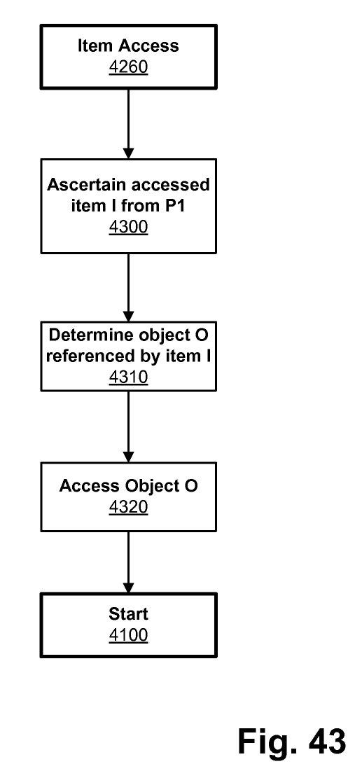

FIG. 43 illustrates a flow of accessing an item. The flow starts with ascertaining 4300 the accessed item I based on the stored pointer position P1. It is then determined 4310 which object O is referenced by item I. The object O is then accessed 4320, and the flow returns to the start 4100.

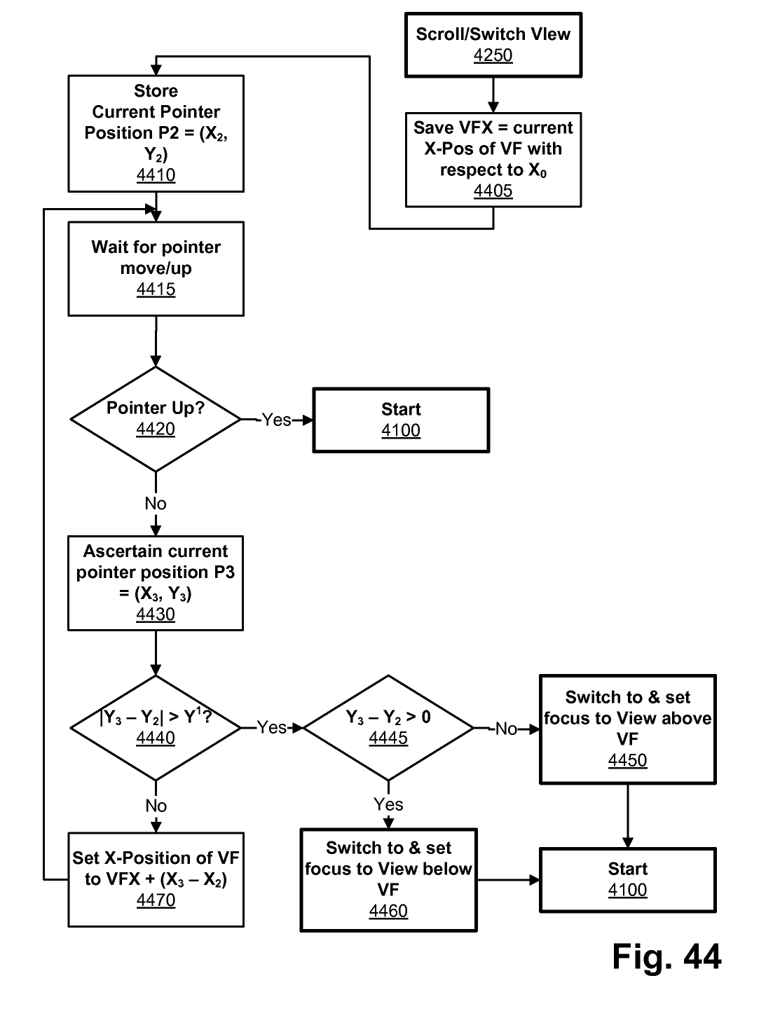

FIG. 44 illustrates a flow for scrolling and switching. The flow starts by saving 4405 the current X-Position of the currently focused view VF with respect to X₀. Then the current pointer position, with both its horizontal and vertical values, is stored 4410 as P2. The flow then waits 4415 for a pointer move/up event. If the pointer event is determined 4420 to be a pointer up, then the flow returns to the start 4100. If the pointer event is determined 4420 not to be a pointer up, then the current pointer position P3, with both its horizontal and vertical values, is ascertained 4430. It is then determined 4440 whether the absolute difference between the horizontal value of P3 and horizontal value of P3 is larger than a threshold value Y¹. If it is determined 4440 not to be larger than the threshold value Y¹, the horizontal position of the currently focused view VF is set to the stored position VFX plus the difference between the horizontal positional value X₃ of the current pointer position P3 and the horizontal positional value X₂ of the stored pointer position P2. The flow then returns to waiting 4415 for a pointer move/up event. If the absolute difference between the horizontal value of P2 and the horizontal value P3 is determined 4440 to be larger than the threshold value Y¹, then it is determined 4445 whether the difference between the vertical positional value Y₃ of the current pointer position P2 and the vertical positional value Y₂ of the stored pointer position P1 is positive. If it is determined 4445 to be positive then the switch to and setting of the focus to a view below the currently focused view VF 4460 is started, and the flow then returns to the start 4100. If it is determined 4445 not to be positive, then the switch to and setting of the focus to a view above the currently focused view VF 4450 is started, and the flow returns to the start 4100.

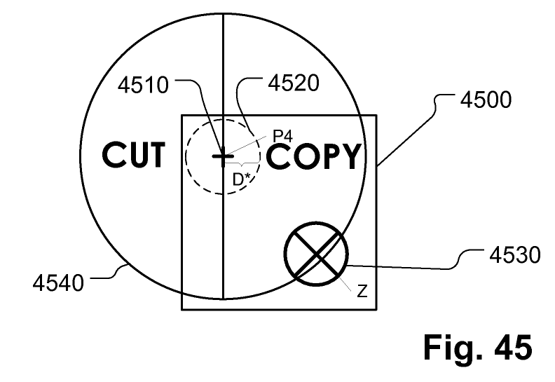

FIG. 45 illustrates an item 4500 with an overlaid delete button 4530 and an item action menu 4540. The item action menu 4510 is displayed at the point P4 (4510) of the pointer down. Further illustrated is a circle 4520, which marks a threshold distance for the detection of a selection from the item action menu 4540.

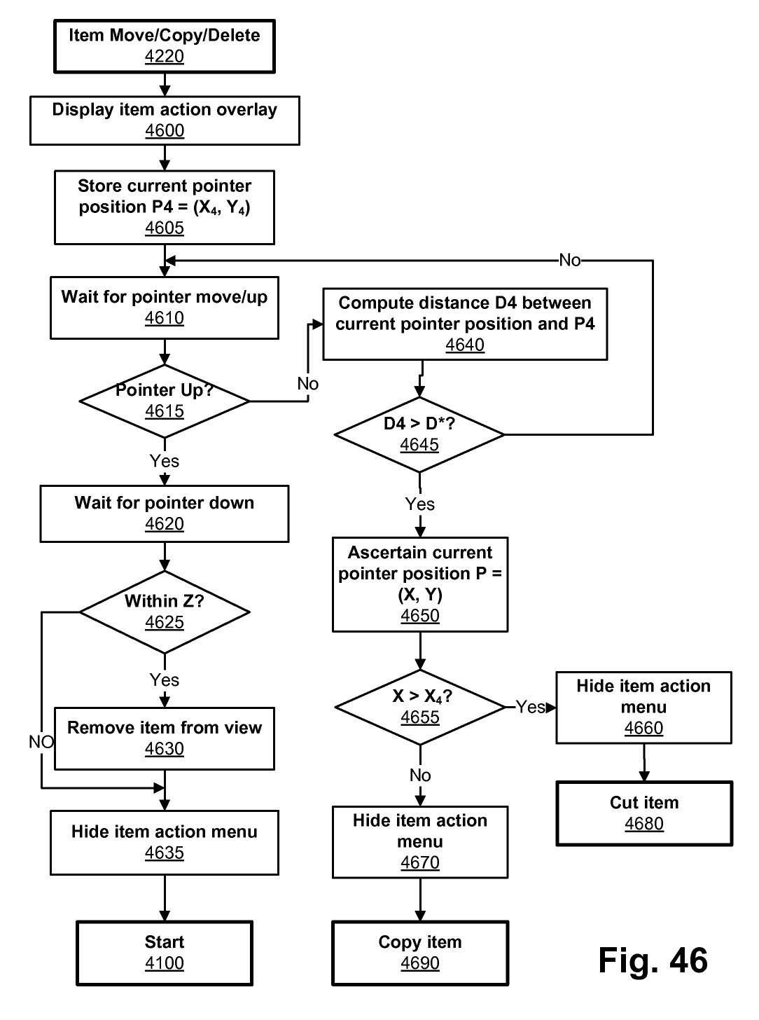

FIG. 46 illustrates a flow for the copying, moving or deleting of an item. The flow starts by displaying 4600 an item action overlay. The current pointer position P4 with both its horizontal and vertical values, is then stored 4605 as P4. The flow then waits 4610 for a pointer move or up event. If a pointer up event is determined 4615, then the flow waits 4620 for a pointer down event. It is then determined 4625 whether the pointer down event falls within the area of delete button Z. If it is determined 4625 not to fall within the area of delete button Z then the item action menu is hidden 4635 and then flow returns to the start 4100. If it is determined 4625 that the pointer down falls within the area of delete button Z then the item is removed 4630 from the view, the item action menu is hidden 4635, and the flow returns to the start 4100. If it is determined 4615 that the pointer event is not a pointer up, then the distance D4 between the current pointer position and the stored pointer position P4 is computed 4640. If distance D4 is determined 4645 not to be larger than a threshold value D*, then the flow returns to waiting 4610 for either a pointer up or a pointer move event. If D4 is determined to be larger than threshold value D*, then the current pointer position P is ascertained 4650 in both its horizontal and vertical values. It is then determined 4655 whether the horizontal value X of the current pointer position is larger than the horizontal value X₄ of the stored pointer position P4. If it is determined 4655 not to be larger, then the item action menu is hidden 4670 and the copying of the item 4690 is started. If it is determined 4655 to be larger, then the item action menu is hidden 4660 and the cutting of the item 4680 is started.

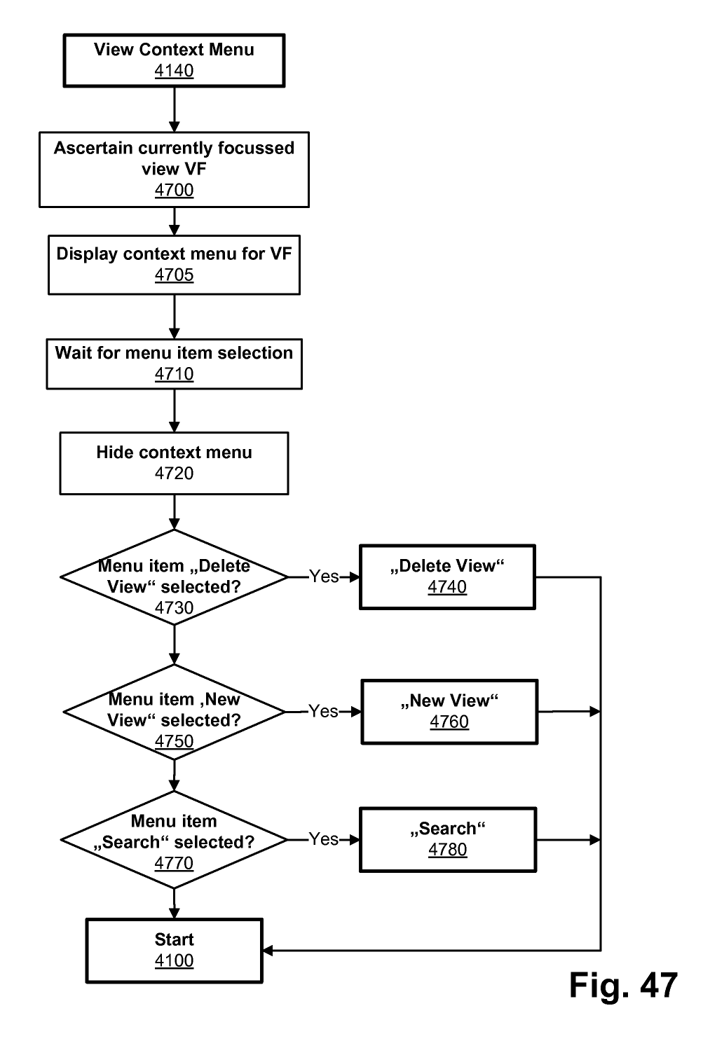

FIG. 47 illustrates a flow for the operation of a view context menu. The flow starts by ascertaining 4700 a currently focused view VF. After this, the context menu for the currently focused view VF is displayed 4705, and the flow waits 4710 for a menu item selection. Once a menu item selection has occurred, the context menu is hidden 4720. It is then determined 4730 whether the menu item “Delete view” has been selected. If it is determined 4730 to have been selected, the “Delete View” 4740 is started and the flow returns to start 4100, else it is determined 4750 whether the menu item “New View” has been selected. If it is determined 4750 that the menu item “New View” has been selected, then “New View” 4760 is started and the flow returns to start 4100, else it is determined 4770 whether menu item “Search” has been selected. If it is determined that the menu item “Search” has been selected, then “Search” 4780 is started, and the flow returns to the start. If it is determined 4770 that the menu item “Search” has not been selected, then the flow returns to start 4100.

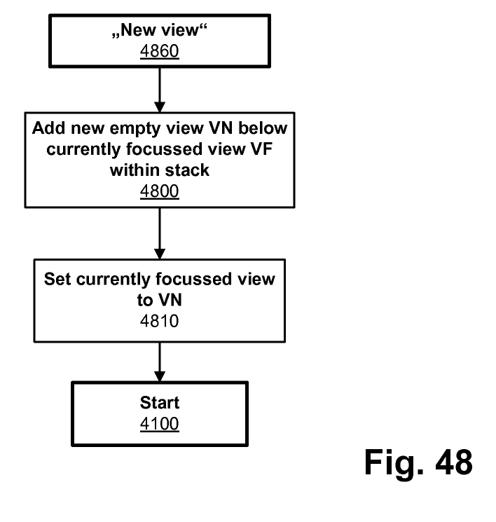

FIG. 48 illustrates a flow for the addition of a new view to the stack of views. First a new empty view VN is added 4800 to the stack below the currently focused view VF. Then the currently focused view is set 4810 to VN. The flow then returns to start 4100.

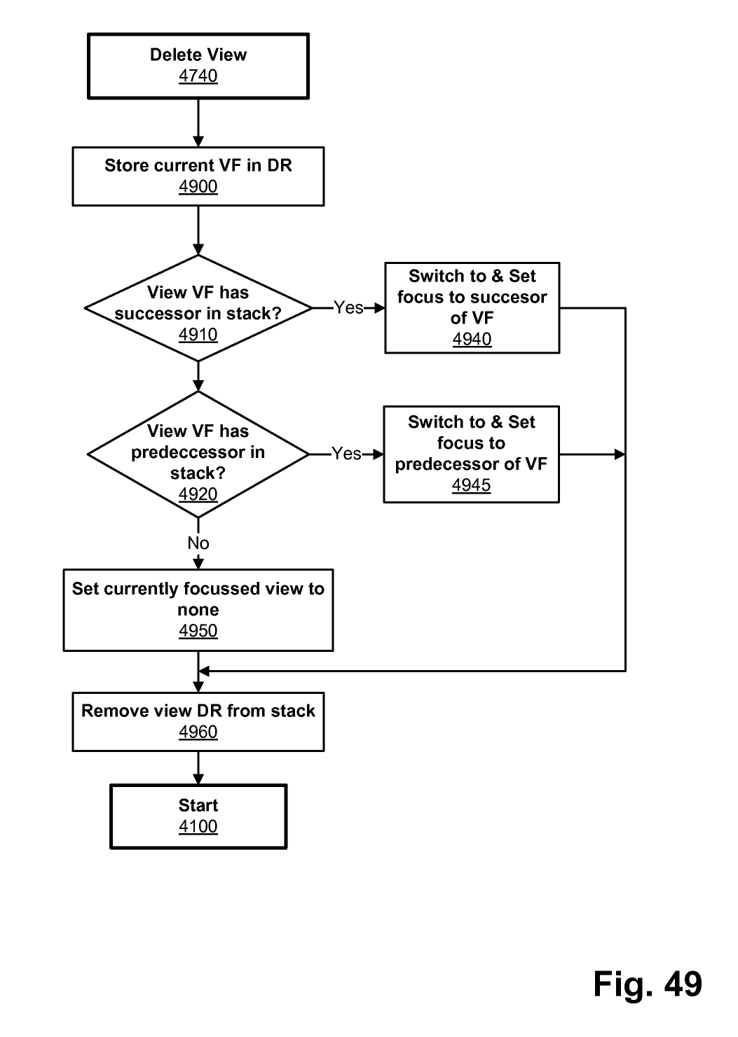

FIG. 49 illustrates a flow for the deletion of a view from the stack of views. The flow starts with storing 4900 the currently focused view VF in DR. It is then determined 4910 whether view VF has a successor in the stack. If it is determined 4910 that view VF has a successor in the stack, then the display of the stack of views is switched 4940 to this successor and the focus is set 4940 to the successor. The view stored in DR is then removed 4960 from the stack and the flow returns to the start 4100. If it is determined 4910 that view VF does not have a successor in the stack, then it is determined 4920 whether view VF has a predecessor in the stack, and if this determination is positive then the display of the stack of views is switched 4945 to this predecessor and the focus is set 4940 to the predecessor. The view stored in DR is then removed 4960 from the stack and the flow returns to start 4100. If it is determined 4920 that view VF does not have a predecessor in the stack, then the currently focused view is set 4950 to none. The view stored in DR is then removed from the stack and the flow returns to start 4100.

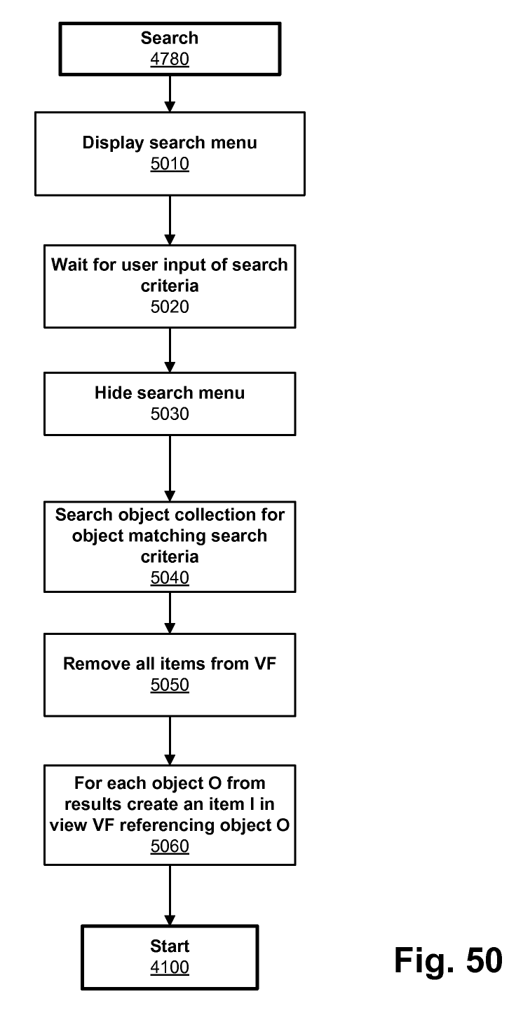

FIG. 50 illustrates a flow for a population of a view through a search on an object collection. The flow starts by displaying 5010 a search menu. The flow then waits 5020 for user input of search criteria. Upon receiving this input, the search menu is hidden 5030 and the object collection is searched 5040 for objects matching the search criteria. All items are removed 5050 from the currently focused view VF. For each object 0 from the results of the search on the object collection, one item I referencing said object O is created in the currently focused view VF. The flow then returns to start 4100.

While here and in other illustrations views are most usually shown in the shape of elongated rectangles, and arrangements of views are most usually shown as a stack of said elongated rectangular views, it will be appreciated that other embodiments may use the above described computing device and methods with other shapes of views and other arrangements of views, even when these methods make no explicit mention of these shapes and arrangements.

What is claimed is:

1. A computing device, comprising:
a display; one or more processors coupled to said display; and a memory coupled to the one or more processors, the memory storing instructions that, when executed by the one or more processors, cause the one or more processors to:
access an electronic object collection;
provide a plurality of views of said electronic object collection,
wherein each view includes one or more items each referencing a respective object from the electronic object collection;
display at least one of said views on the display;
wherein the display of the view includes a display of at least one of the one or more items included in said view;
populate a view with items referencing objects from the results of a search function on said electronic object collection in response to a user input or program-controlled;
access an object referenced by an item in a view in response to a user input for said item;
delete an item from a given view in response to a user input or program-controlled;
wherein deletion of an item referencing an object in the electronic object collection does not delete the referenced object from the object collection;
copy an item from a first view into a second view in response to a user input or program controlled;
wherein the copying does not include copying the object in the object collection referenced by the item; and
move and item from a first view onto a second view in response to a user input or program controlled.

2. The computing device of claim 1, where the objects in the electronic object collection are at least one of word processing documents, spreadsheet documents, presentation documents, documents in a format that preserves document fidelity when displayed, ASCII text files, Unicode text files, HTML files, XML files, sound files, video files, database files, source code files and image files.

3. The computing device of claim 1, where the instructions stored in the memory further cause the one or more processors to
display tags assigned to objects in the object collection, and populate a search query for the search function with tags selected from the displayed tags.

4. The computing device of claim 1, where the instructions stored in the memory further cause the one or more processor to
in response to a user accessing an object via an item referencing it, or program-controlled, execute at least one of
rendering the content of an object in an internal viewer
and invoking an external application to render the content of an object.

5. The computing device of claim 1, where the instructions stored in the memory further cause the one or more processors to
determine, from a set of actions relating to an item, an action to be performed on said item based on the initial direction of a drag of that item.

6. The computing device of claim 5, where the set of actions relating to an item are at least two of moving the item, copying the item, deleting the item, tagging the item, and accessing the item.

7. The computing device of claim 1, wherein the instructions stored in the memory further cause the one or more processors to
change at least one of the size of the display of the view and the display of the items the view includes based on a display state of a view.

8. The computing device of claim 1, wherein the instructions stored in the memory further cause the one or more processors to
change the display of an item depending on at least one of the type of object the item references and the content of the object the item references.

9. The computing device of claim 1, where the display of an item is at least one of a thumbnail of a document object content, a graphical representation of the sound wave of a sound file object, a still image from a video object, a display of a thumbnail of the video object being played, an icon representing one of a set of object types, an icon representing an application the object was created by and a display of the number of pages of a document object.

10. The computing device of claim 1, where the instructions stored in the memory further cause the one or more processors to
change the arrangement of the items in a view in response to a user input or program controlled.

11. The computing device of claim 10 where such user input may include dragging an item from an initial position within a view to a final position within said view.

12. The computing device of claim 1, wherein the instructions stored in the memory further cause the one or more processors to
arrange the plurality of views in the form of a stack of rectangular views, and
change the position of a view relative to the other views in a direction perpendicular the axis of the stack in response to a user input or program controlled.

13. The computing device of claim 12, where the instructions stored in the memory further cause the one or more processors to execute at least one of
adding a view to the stack,
deleting a view from the stack, and
changing the order of views in the stack
in response to a user input or program controlled.

14. The computing device of claim 1, where the instructions stored in the memory further cause the one or more processors to
pan a viewport on a view or an arrangement of views in response to a user input or program controlled
where the viewport is smaller than the view or the arrangement of views in their respective current display state.

15. The computing device of claim 1, where the instructions stored in the memory further cause the one or more processors to
populate a view with one of
the union set of the respective sets of items included in two or more views,
the intersection set of the respective sets of items included in two or more views, and
the symmetrical difference set of the respective sets of items included in two or more views
in response to a user dragging one or more views onto one or more other views.

16. A method for accessing an electronic object collection via a plurality of views comprising
accessing an electronic object collection;
providing a plurality of views of said electronic object collection,
wherein each view includes one or more items each referencing a respective object from the electronic object collection;
displaying at least one of said views on the display;
wherein the display of the view includes a display of at least one of the one or more items included in said view;
populating a view with items referencing objects from the results of a search function on said electronic object collection in response to a user input or program-controlled;
accessing an object referenced by an item in a view in response to a user input for said item;
deleting an item from a given view in response to a user input or program-controlled;
wherein the deletion of an item referencing an object in the electronic object collection does not delete the referenced object from the object collection;
copying an item from a first view into a second view in response to a user input or program controlled;
wherein the copying does not include copying the object in the object collection referenced by the item; and
moving and item from a first view onto a second view in response to a user input or program controlled.

17. The method of claim 16, where the objects in the electronic object collection are at least one of word processing documents, spreadsheet documents, presentation documents, documents in a format that preserves document fidelity when displayed, ASCII text files, Unicode text files, HTML files, XML files, sound files, video files, database files, source code files and image files.

18. The method of claim 16, further comprising
displaying tags assigned to objects in the object collection; and
populating a search query for the search function with tags selected from the displayed tags.

19. The method of claim 16, further comprising at least one of
rendering the content of an object in an internal viewer upon a user accessing said object via an item referencing it, or program-controlled; and
invoking an external application to render the content of an object upon a user accessing said object via an item referencing it, or program-controlled.

20. The method of claim 16, further comprising
determining, from a set of actions relating to an item, an action to be performed on said item based on the initial direction of a drag of that item,
wherein said set of actions are at least two of moving the item, copying the item, deleting the item, tagging the item, and accessing the item.

21. The method of claim 16, where the display of an item may vary depending on the type of object the item references, and
wherein said display of an item is at least one of a thumbnail of a document object content,
a graphical representation of the sound wave of a sound object, a still image from a video object, a display of a thumbnail of the video object being played, an icon representing one of a set of object types, an icon representing an application the object was created by and a display of the number of pages of a document object.

22. The method of claim 16, further comprising
changing the arrangement of the items in a view in response to a user input or program controlled,
wherein said user input may include dragging an item from an initial position within a view to a final position within said view.

23. The method of claim 16, further comprising
arranging the plurality of views in the form of a stack of rectangular views, and
changing the position of a view relative to the other views in a direction perpendicular the axis of the stack in response to a user input or program controlled.

24. The method of claim 23, further comprising
adding a view to the stack, deleting a view from the stack, and changing the order of views in the stack in response to a user input or program controlled.

25. The method of claim 16, further comprising
populating a view with one of
the union set of the respective sets of items included in two or more views,
the intersection set of the respective sets of items included in two or more views, and the symmetrical difference set of the respective sets of items included in two or more views in response to a user dragging one or more views onto one or more other views.

26. A computer-readable medium storing instructions that, when executed, cause one or more processors to
access an electronic object collection;
provide a plurality of views of said electronic object collection, wherein each view includes one or more items each referencing a respective object from the electronic object collection;
display at least one of said views on the display;
wherein the display of the view includes a display of at least one of the one or more items included in said view;
populate a view with items referencing objects from the results of a search function on said electronic object collection in response to a user input or program-controlled;
access an object referenced by an item in a view in response to a user input for said item;
delete an item from a given view in response to a user input or program-controlled;
wherein deletion of an item referencing an object in the electronic object collection does not delete the referenced object from the object collection;
copy an item from a first view into a second view in response to a user input or program controlled;
wherein the copying does not include copying the object in the object collection referenced by the item; and
move and item from a first view onto a second view in response to a user input or program controlled.
